(19) United States
(12) Patent Application Publication
(10) Pub. No.: US 2022/0400385 A1
(43) Pub. Date: Dec. 15, 2022

(54) MULTI-SPECTRUM AND MULTI-NETWORK COMMUNICATION SYSTEM

(71) Applicant: Frequencz AB, Stockholm (SE)

(72) Inventors: Thomas Eklund, Stockholm (SE); Erik Berg, Strangnas (SE); Olof Hagsand, Alta (SE)

(21) Appl. No.: 17/734,056

(22) Filed: Apr. 30, 2022

Related U.S. Application Data
(60) Provisional application No. 63/183,408, filed on May 3, 2021.

(51) Int. Cl. H04W 16/14

(52) U.S. Cl. CPC H04W 16/14

(57) ABSTRACT

Described is a Multi-Spectrum and Multi-Network Communication (MSMNC) system for communicating with at least one user equipment (UE) over a plurality of unlicensed communication core networks (generally and interchangeably referred to as “unlicensed core networks”) and at least one licensed spectrum communication core network (generally and interchangeably referred to as “unlicensed core networks”), where each unlicensed communication core network operates over a first band of unlicensed wireless frequencies and each licensed communication core network operates over a second band of licensed wireless frequencies.

### CROSS-REFERENCE TO RELATED APPLICATION

This application claims priority under 35 U.S.C. § 119(e) of U.S. Provisional Patent Application No. 63/183,408, filed May 3, 2021, entitled Multi-Spectrum and Multi-Network Communication System Utilizing Spectrum Virtualization and Curation by Thomas Eklund, Erik Berg and Olof Hagsand, which application is incorporated by reference herein.

### BACKGROUND

### 1. Field

The present disclosure is related to telecommunication systems, and more specifically, to telecommunication systems that utilize virtualization.

### 2. Prior Art

Mobile communications have evolved significantly from early voice systems to today's highly sophisticated integrated communication platform. With the increase in different types of devices communicating with various network devices, usage of third Generation Partnership Project (3GPP) long-term evolution (LTE) systems have increased. The penetration of mobile devices (also known as user equipment (UE)) in modern society has continued to drive demand for a wide variety of networked devices in several disparate environments. At present, fifth generation (5G) wireless systems have enabled greater speed, connectivity, and usability then the previous systems. Additionally, next generation 5G networks (5G-NR networks) are expected to increase throughput, coverage, and robustness and reduce latency and operational and capital expenditures. 5G-NR networks are evolving based on 3GPP LTE-Advanced with additional potential new radio access technologies (RATs) to enrich people's lives with seamless wireless connectivity solutions delivering fast, rich content, and services. As the current allocated (i.e., licensed) cellular network frequencies are saturated, potential LTE operation in the unlicensed spectrum is being considered. In this disclosure, the unlicensed spectrum is considered the portion (i.e., the frequency bands) of the radio spectrum that is assigned to every citizen for non-exclusive usage potentially subject to some regulatory constraints. Unlike the unlicensed section, the licensed spectrum is the portion of the radio spectrum that is assigned exclusively to operators for independent usage. This unlicensed spectrum includes, and is not limited to, LTE operation in the unlicensed spectrum via dual connectivity (DC), or DC-based license assisted access (LAA), and standalone LTE systems in the unlicensed spectrum.

Further enhanced operation of LTE systems in the licensed, as well as unlicensed spectrum, is expected in future releases and 5G-NR systems. Such enhanced operations may include techniques to address enabling network slicing in a 5G-NR radio access network (RAN) with control plane (CP)/user plane (UP) separation using different RAN interfaces.

In addition to these systems, recently many organizational, business, governmental, and/or enterprise entities have begun to build their own private LTE networks (also known as Private LTE Campus Networks or generally as “private LTE networks”) utilizing known available resources.

These entities commonly include, for example, utilities, factories, police departments, universities, or businesses. Only authorized users of that entity have access to the network of the entity. The manager of a private LTE network decides how the network will perform, who has access and who has priority. In contrast, public LTE networks offered by Mobile Network Operators (MNOs) such as the networks offered by Verizon, AT&T are operated for the benefit of anyone willing to pay a monthly fee to the MNO.

Current implementations of these types of networks have exceedingly high capital and operational costs to build and operate. To install and operate a private LTE network, an entity has the option of purchasing licensed spectrum from the government, like the U.S. Federal Communications Commission (FCC), or from an MNO or other third-party spectrum provider. Unfortunately, even with the increase bandwidth of 5G type networks, this gain in spectrum will generally not meet the forecasted demand for additional bandwidth. Therefore, even with the introduction and expansion of 5G networks, the demand for licensed spectrum will quickly overwhelm the available supply.

As such, there has been a move to utilize the unlicensed radio spectrum to address this growing need. As a result, to more efficiently utilize the limited resources of spectrum to meet the ever-increasing demands of the public, government agencies like the FCC have recently offered a shared spectrum scheme for the unlicensed spectrum. In the U.S., for example, this is known as the Citizens Broadband Radio Service (CBRS) spectrum access system (SaS). The CBRS spectrum classifies licensees in three tiered levels, described further below.

The CBRS was established by the FCC in 2015 for shared commercial use of the 3,550-3,700 MHz band (3.5 GHz band) in the U.S. This service is intended to offer a large number of spectrum licenses available for bidding to further the deployment 5G, the Internet-of-Things (IoT), and other advanced spectrum services. Access and operation of the CBRS is managed by an automated frequency coordinator, known as the SaS.

When managing spectrum access, the SaS may incorporate information from the environmental sensing capability (ESC) that is a sensor network that detects transmissions from the U.S. Department of Defense radar systems and transmits that information to the SASs. In this U.S., both SaSs and ESCs must be approved by the FCC. SaSs coordinate operations between and among users in three tiers of authorization in the 3.5 GHz band: incumbent access (IA), priority access licensed (PAL) and general authorized access (GAA). The rules governing the operation of the CBRS are found in part 96 of the FCC rules.

The IA users include authorized government agencies in the 3,550-3,700 MHz band, such as, for example, military radar systems. In addition, the IA users are fixed satellite service (space-to-Earth) earth stations in the 3,600-3,650 MHz band, and, for a finite time, grandfathered wireless broadcast licensees in the 3,650-3,700 MHz band. The IA users receive protection against harmful interference from PAL and GAA users.

In this example, the priority access users consist of PALs that received auctioned spectrum on a county-by-county basis. Each PAL has a 10-year renewable license to a 10 MHz channel within the 3,550-3,650 MHz band. Up to seven PALs may be licensed in any given county, subject to a four PAL channel aggregation cap for any one licensee. The PALs must protect and accept interference from the IA users but receive protection from the GAA users.

Moreover, in this example, the GAA tier is licensed-by-rule to permit open, flexible access to the band for the widest possible group of potential users. The GAA users operate throughout the 3,550-3,700 MHz band. In this approach, the GAA users must not cause harmful interference to IA users or PALs and must accept interference from these users. The GAA users also have no expectation of interference protection from other GAA users.

Unfortunately, while CBRS is relatively new and has great potential, this potential is currently untapped and wasted, at least from the standpoint of an entity seeking to leverage this shared spectrum for use as a private network. As such, there is a need for a system and method for managing and integrating the frequencies covered by the CBRS band, in addition to leveraging other available bands. There is also a need to lower the capital investment needed to build and operate these private networks utilizing these bands. Furthermore, there is a need for allocating the licensed and unlicensed spectrums.

### SUMMARY

A Multi-Spectrum and Multi-Network Communication (MSMNC) system for communicating with at least one user equipment (UE) over a plurality of unlicensed communication core networks (generally and interchangeably referred to as “unlicensed core networks”) and at least one licensed spectrum communication core network (generally and interchangeably referred to as “unlicensed core networks”) is described. Each unlicensed communication core network operates over a first band of unlicensed wireless frequencies and each licensed communication core network operates over a second band of licensed wireless frequencies. The MSMNC system comprises a virtual radio access network (vRAN), an unlicensed interference management (UIM) system, and a spectrum management (SC) system. The vRAN is configured to provide a first communications link with the at least one UE, the vRAN including a plurality of control layers. The UIM system is configured to manage a frequency of operation of the vRAN within the first band of unlicensed wireless frequencies and the SC system is configured to provide spectrum slicing of the first band of unlicensed wireless frequencies.

As an example of operation, the MSMNC performs a method that includes providing a first communications link with the at least one UE utilizing the vRAN; managing a frequency of operation of the vRAN within the first band of unlicensed wireless frequencies utilizing the UIM system; and providing spectrum slicing of the first band of unlicensed RF frequencies with a spectrum management system.

Also disclosed is a MSMNC system for dynamically communicating over both licensed and unlicensed bands of a radio spectrum. The MSMNC comprises a physical infrastructure including a pool of resources, an UIM system, a spectrum management system, and a computer readable medium on the memory configured to store machine instructions than when executed by the at least one processor causes the MSMNC system to create a plurality of slices of a vRAN. The pool of resources includes a memory, at least one processor, a network infrastructure, a plurality of transport networks, and access and core networks. The plurality of transport networks includes a first transport network configured for operation on a first unlicensed portion of the radio spectrum and a second transport network configured for operation on a second unlicensed portion of the radio spectrum. Each vRAN slice of the plurality of RAN slices are dynamically isolated from the pool of network resources.

The MSMNC system in operation performs a method that includes trading spectrum usage in the MSMNC system between spectrum providers and tenants. The spectrum is allocated by a regulator that arbitrates any conflict of unlicensed radio frequencies and the spectrum ledger validates the buying and selling of new mobile networks and virtual private networks. The spectrum manager verifies the availability and usage of spectrum assets in the following steps provisioning raw spectrum inventory and aggregating spectrum to tenants.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a system block diagram of an example of an implementation of a communication system having a multi-spectrum and multi-network communication (MSMNC) system in accordance with the present disclosure.

FIG. 2 is a system block diagram of an example of an implementation of the MSMNC system, shown in FIG. 1, in accordance with the present disclosure.

FIG. 3 is a system block diagram on an example of an implementation of a virtual radio access network (vRAN) shown in FIG. 2 in accordance with the present disclosure.

FIG. 4 is a graph of capacity requirement for communication networks are shown as a function of coverage area based on the type of area serviced.

FIG. 5 is a system block diagram an example of an implementation of a vRAN used in a multi-dwelling unit or office in accordance the present disclosure.

FIG. 6 is a system block diagram of an example of an implementation of the physical infrastructure shown in FIG. 2 in accordance with the present disclosure.

FIG. 7 is a system block diagram of an example of another implementation of the physical infrastructure shown in FIG. 2 in accordance with the present disclosure.

FIG. 8 is a system block diagram of an example of an implementation of virtual slices of vRAN shown in FIG. 2 in accordance with the present disclosure.

FIG. 9 is a system block diagram an example of an implementation of a DU with memory, CPUs, and a FEC accelerator in accordance with the present disclosure.

FIG. 10 is a system block diagram an example of an implementation of a DU connected to a virtualization manager where the virtualization manager has a connection to the radio infrastructure hypervisor located within the DU in accordance with the present disclosure.

FIG. 11 is a system block diagram of an example of an implementation of the radio infrastructure hypervisor in CU in accordance with the present disclosure.

FIG. 12 is a system block diagram of an example of an implementation of DU with a radio infrastructure hypervisor, three slices, and an external virtualization manager in accordance with the present disclosure.

FIG. 13 is a system block diagram of an example of virtual manager connected to multiple RUs, DUs, CUs, and integrated RU-DU-CUs in accordance with the present disclosure.

FIG. 14 is a system diagram of an example of an implementation of a plurality of spectrum resource managers connected the RUs and DUs to enable virtual spectrum slices in accordance with the present disclosure.

FIG. 15 is a system block diagram of an example of an implementation of a virtual spectrum slice in accordance with the present disclosure.

FIG. 16 is a block system diagram of the sub-components of a site in accordance with the present disclosure.

FIG. 17 is a block system diagram of an example of an implementation of radio infrastructure hypervisor and managed element shown in FIG. 16 in accordance with the present disclosure.

FIG. 18A is a block system diagram of an example of an implementation of a site with a fronthaul and RU in accordance with the present disclosure.

FIG. 18B is a block system diagram of an example of an implementation of a Master 1558 in accordance with the present disclosure.

FIG. 19 is a flowchart of a method performed by a spectrum hypervisor in accordance with the present disclosure.

FIG. 20A is a flowchart of a method performed by a spectrum hypervisor in accordance with the present disclosure.

FIG. 20B is a flowchart of a method performed by a spectrum hypervisor in accordance with the present disclosure.

FIG. 20C is a flowchart of a method performed by a spectrum hypervisor in accordance with the present disclosure.

FIG. 21A is a flowchart of a method performed by a flowchart mixer utilizing fronthaul messages from infrastructure slices of a DU in accordance with the present disclosure.

FIG. 21B is a flowchart of a method performed by a flowchart mixer utilizing fronthaul messages to infrastructure slices of the DU in accordance with the present disclosure.

FIG. 22A is system block diagram of a part of a DU related to a scheduler and physical layer in accordance with the present disclosure.

FIG. 22B is a flowchart of a method performed by a schedular in accordance with the present disclosure.

FIG. 22C is a flowchart of a method performed by the schedular with virtual spectrum slice support in accordance with the present disclosure.

FIG. 23A is a flowchart of a method performed by the virtual spectrum manager for a spectrum use collection process in accordance with the present disclosure.

FIG. 23B is a flowchart of a method performed by the virtual spectrum manager for a spectrum distribution process in accordance with the present disclosure.

FIG. 24A is a flowchart of a method performed by the virtual spectrum manager for an allocation new spectrum slice process in accordance with the present disclosure.

FIG. 24B is a flowchart of a method performed by the virtual spectrum manager for delete spectrum slice process in accordance with the present disclosure.

FIG. 25 is a system block diagram of an example of an implementation of the virtual spectrum manager in accordance with the present disclosure.

FIG. 26A is flowchart of a method performed by the radio infrastructure hypervisor for delete spectrum slice process in accordance with the present disclosure.

FIG. 26B is flowchart of another method performed by the radio infrastructure hypervisor for delete spectrum slice process in accordance with the present disclosure.

FIG. 27A is flowchart of yet another method performed by the radio infrastructure hypervisor for delete spectrum slice process in accordance with the present disclosure.

FIG. 27B is flowchart of still another method performed by the radio infrastructure hypervisor for delete spectrum slice process in accordance with the present disclosure.

FIG. 27C is flowchart of another method performed by the radio infrastructure hypervisor for delete spectrum slice process in accordance with the present disclosure.

FIG. 27D is flowchart of yet another method performed by the radio infrastructure hypervisor for delete spectrum slice process in accordance with the present disclosure.

FIG. 28A is a system block diagram of a sliced infrastructure node and network example in accordance with the present disclosure.

FIG. 28B is a table of a sliced infrastructure node and network example in accordance with the present disclosure.

FIG. 28C is another table of a sliced infrastructure node and network example in accordance with the present disclosure.

FIG. 29 is a block diagram of an edge plus cloud site in accordance with the present disclosure.

FIG. 30 is a system block diagram of an example of an implementation of an infrastructure slice, spectrum mixer, and radio hypervisor at a centralized unit and distributed unit at an edge site in accordance with the present disclosure.

FIG. 31 is a system block diagram of an example of an implementation of the MMCS in accordance with the present disclosure.

FIG. 32 is a functional system block diagram of an example of an implementation of the flow of spectrum usage in accordance with the present disclosure.

FIG. 33 is a block diagram of an example of the physical and virtual systems for network provisioning in accordance with the present disclosure.

FIG. 34 is a functional system block diagram of an example of an implementation of the flow of trading spectrum in the marketplace envisioned in accordance with the present disclosure.

FIG. 35 is a block diagram of an edge plus cloud site in accordance with the present disclosure.

FIG. 36 is a system block diagram of an example of an implementation of an infrastructure slice, spectrum mixer, and radio hypervisor at a centralized unit and distributed unit at an edge site in accordance with the present disclosure.

FIG. 37 is a functional system block diagram of an example of an implementation of the flow of trading spectrum in the marketplace envisioned in accordance with the present disclosure.

### DESCRIPTION

Described is a Multi-Spectrum and Multi-Network Communication (MSMNC) system for communicating with at least one user equipment (UE) over a plurality of unlicensed communication core networks (generally and interchangeably referred to as “unlicensed core networks”) and at least one licensed spectrum communication core network (generally and interchangeably referred to as “unlicensed core networks”), where each unlicensed communication core network operates over a first band of unlicensed wireless frequencies and each licensed communication core network operates over a second band of licensed wireless frequencies. The MSMNC system comprises a virtual radio access network (vRAN), an unlicensed interference management (UIM) system, and a spectrum management (SC) system. The vRAN is configured to provide a first communications link with the at least one UE, the vRAN including a plurality of control layers. The UIM system is configured to manage a frequency of operation of the vRAN within the first band of unlicensed wireless frequencies and the SC system is configured to provide spectrum slicing of the first band of unlicensed wireless frequencies.

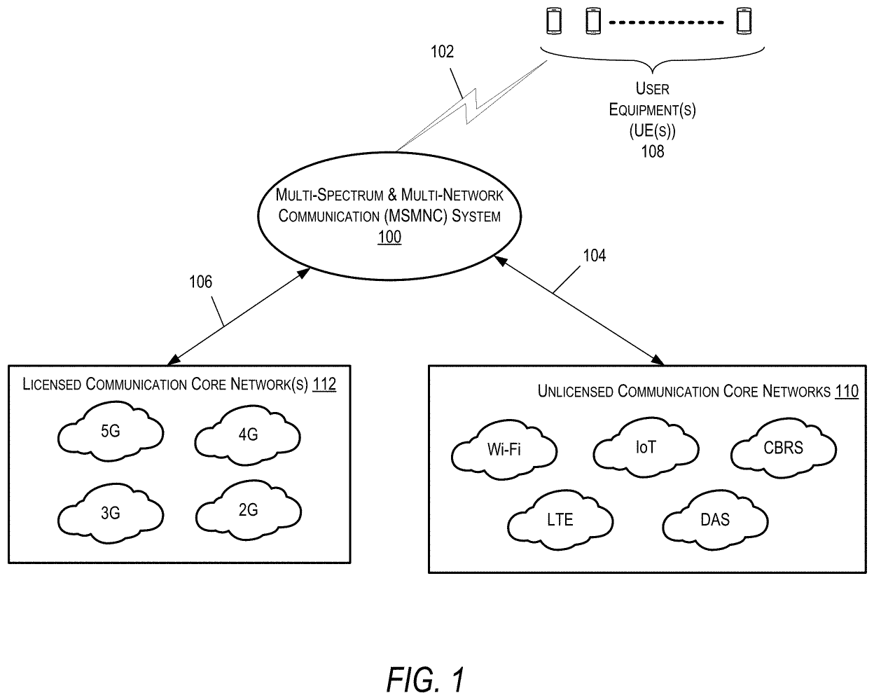

Specifically, in FIG. 1, a system block diagram of an example of an implementation of a communication system having a MSMNC system 100 is shown in accordance with the present disclosure. The MSMNC System 100 in signal communication (via signal paths 102, 104, and 106) with at least one UE 108 over a plurality of plurality of unlicensed communication core networks 110 and at least one licensed spectrum communication core network 112. In this example, the unlicensed communication core networks 110 may include an IEEE 802.11 Wi-Fi network, Internet-of-Things (IoT) network, Citizens Broadband Radio Service (CBRS) network, long-term evolution (LTE) network, distributed antenna system (DAS) network, etc. The licensed spectrum communication core networks 112 may include, for example, a 2G, 3G, 4G, 5G, and 5G-NR network.

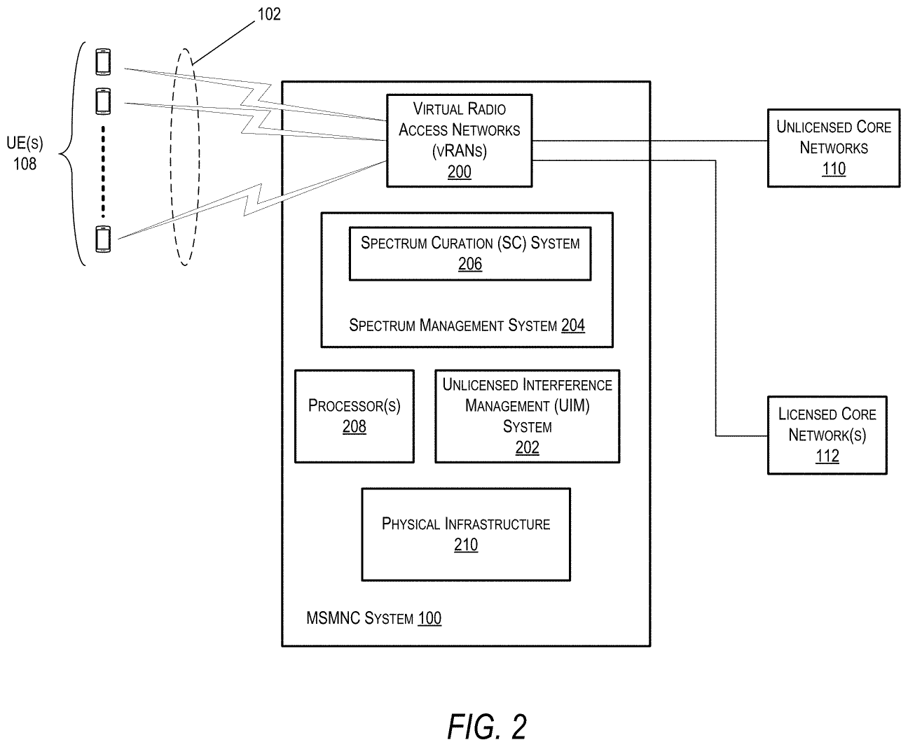

In FIG. 2, a system block diagram of an example of an implementation of the MSMNC system 100 is shown in accordance with the present disclosure. The MSMNC system 100 includes one or more vRANs 200, an UIM system 202, and spectrum management system 204. In this example, the vRANs 200 may include one or more vRANs where each vRAN is configured to provide a first communications link 206 (via signal path 102) with the at least one UE(s) 108, each vRAN of the vRAN 200 includes a plurality of control layers and may be a hardware slice of RAN within the MSMNC 100. The UIM system 202 is configured to manage a frequency of operation of the vRAN 200 within the first band of unlicensed wireless frequencies and the spectrum management system 204 is configured to provide spectrum slicing of the first band of unlicensed wireless frequencies corresponding to the unlicensed core networks 110. The spectrum management system 204 may also be configured to provide spectrum slicing of the second band of licensed wireless frequencies corresponding to the licensed core network(s) 112.

In this example, the UIM system 202 is a component, system, circuit, the software module that may include a monitoring system that monitors the unlicensed wireless frequencies of the unlicensed radio spectrum to see if other entities are using those wireless frequencies. In an example of operation in the CBRS radio spectrum (i.e., the band 3,550-3,700 MHz (3.5 GHz band) of wireless frequencies), the U.S. Federal Communications Commission (FCC) provides a shared spectrum scheme for the unlicensed radio spectrum utilizing an automated frequency coordinator known as the spectrum access system (SaS).

When managing spectrum access to the CBRS radio spectrum, the SaS may incorporate information from the environmental sensing capability (ESC) where the ESC is a sensor network that detects transmissions from the U.S. Department of Defense radar systems and sends that information to the SAS. The SaS coordinates operations between and among users (e.g., UE(s) 108) in three tiers of authorization in the 3.5 GHz band that include incumbent access (IA), priority access licensed (PAL) and general authorized access (GAA). The rules governing the operation of the CBRS are found in part 96 of the FCC rules.

In operation, the IA users include authorized government agencies in the 3,550-3,700 MHz band, such as, for example, military radar systems. In addition, the IA users are fixed satellite service (space-to-Earth) earth stations in the 3,600-3,650 MHz band, and, for a finite time, grandfathered wireless broadcast licensees in the 3,650-3,700 MHz band. The IA users receive protection against harmful interference from PAL and GAA users.

In this example, the priority access users consist of PALs that received auctioned spectrum from the FCC. In general, each PAL has a renewable license to a 10 MHz channel within the 3,550-3,650 MHz band and up to seven PALs may be licensed in any given area, subject to a four PAL channel aggregation cap for any one licensee. The PALs must protect and accept interference from the IA users but receive protection from the GAA users by the FCC.

Moreover, in this example, the GAA tier is licensed-by-rule to permit open, flexible access to the band for the widest possible group of potential users. The GAA users operate throughout the 3,550-3,700 MHz band. In this approach, the GAA users must not cause harmful interference to IA users or PALs and must accept interference from these users. The GAA users also have no expectation of interference protection from other GAA users.

As such, in this example, the UIM system 202 may work and/or communicate with the SAS to ensure that there is no interference with users (i.e., GAA users and possibly PALs) of the MSMNC system 100. The UIM system 202 may also work and/or communicate with one or more ESCs. In this example, the MSMNC system 100 may be part of a PAL or an independent system that operates with multiple GAA users on multiple spectrums controlled by one or more PALs.

While CBRS has been described, the UIM system 202 may also monitor the unlicensed wireless frequencies of the unlicensed radio spectrum that correspond to the Wi-Fi, IoT, LTE, and DAS systems. As another example, the UIM system 202 may also monitor the licensed wireless frequencies of the licensed radio spectrum to see if other entities are using those wireless frequencies.

The spectrum management system 204 may also be configured to provide spectrum slicing of the first band of unlicensed wireless frequencies corresponding to the unlicensed core network 110. The spectrum management system 204 includes a spectrum curation (SC) system 206 that is configured to select, organize, and monitor spectrum slices of the first band of unlicensed wireless frequencies corresponding to the unlicensed core networks 110. The SC system 206 may also be configured to select, organize, and monitor spectrum slices of both the first band of unlicensed wireless frequencies and the second band of licensed wireless frequencies.

The MSMNC system 100 may also include one or more processors 208 and a physical infrastructure 210. The one or more processors 208 may optionally be part of the physical infrastructure 210. In this example, each vRAN of the vRANs 200 may be a virtualization of the RAN that each includes a virtual antenna, virtual radio unit, a virtual front haul network, and a virtual baseband unit. These virtualizations are created utilizing the common electronic circuitry of the physical infrastructure 210 that includes antenna systems, transceiver circuitry, baseband circuitry, controllers, system memory, network interfaces, and at least one processor (e.g., processor(s) 208). These virtualizations emulate the operation of a RAN such that the vRANs 200 emulate the operation of different types of RANs running on common and potential generic hardware such as the physical infrastructure 210.

In this example, the virtualized antenna of the vRAN 200 may be a virtualization of a multiple-in multiple-out (MIMO) antenna that is part of the physical infrastructure 210. The MIMO antenna is configured to allow the vRAN 200 to utilize special (i.e., signaling) degrees of freedom that can be utilized by the MSMNC system 100 for diversity and/or spatial multiplexing of signals at the same frequency band increasing throughput linearly without increasing bandwidth usage or transmit power.

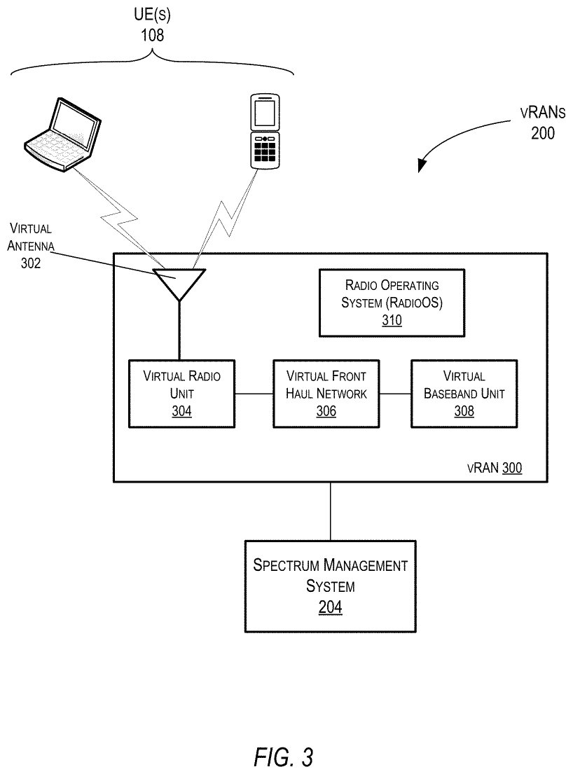

In FIG. 3, a system block diagram on an example of an implementation of the vRAN 200 is shown in accordance with the present disclosure. In this example, the vRAN 200 includes at least one vRAN 300 that includes a virtual antenna 302, a virtual radio unit 304, a virtual front-haul network 306, a virtual baseband unit (BBU) 308, and a radio operating system (RadioOS) 310. The virtual antenna 302 is in signal communication with the UE(s) 108. The vRAN 300 is in signal communication with the spectrum management system 204.

In this example, the vRAN 200 is a software radio with the integrated antenna 302 to be a programmable radio. The RadioOS includes a distributed radio access controller configured to control the vRAN to communicate over multiple frequency spectrums and/or multiple networks (that may vary by format, modulation, etc.). The RadioOS allows the vRAN 300 to communicate via, for example, shared license spectrum networks (i.e., licensed core network(s)) such as, for example, 3G, 4G, or 5G networks and shared unlicensed spectrum networks (i.e., unlicensed core networks 110) such as, for example, CBRS, IoT, Wi-Fi, LTE, or other communication networks. The spectrum management system 204 and UIM system 202 are SaS based radio planning and provisioning system that allows for the creation and management of unlicensed private networks (utilizing the unlicensed core networks 110) for the MSMNC system 100.

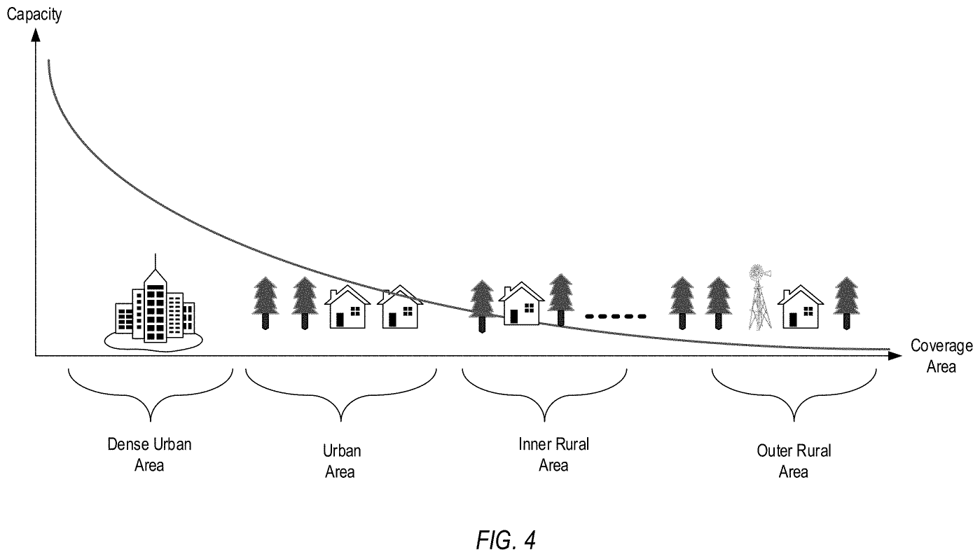

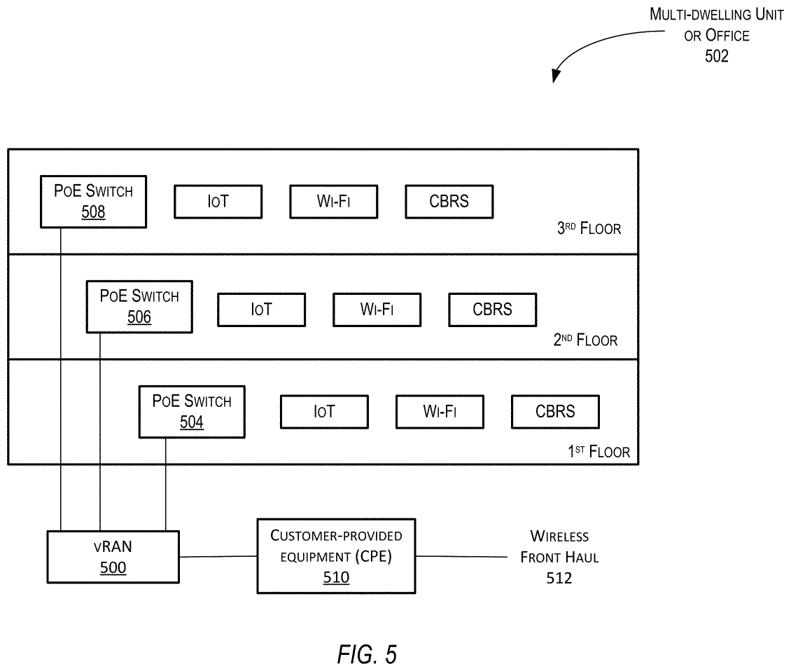

In this example, the MSMNC system 100 allows for radio virtualization of workloads in the virtual BBU 308, radio slicing/spectrum virtualization, network slicing/multi-tenancy, minimize virtual fronthaul transport 306 (i.e., the radio unit to the base station), use of a reprogrammable spectrum, enhanced interference management, and multi-network capabilities. As such, the MSMNC system 100 allows the unification of low, mid, and high-frequency bands for corporate IT indoor and outdoor use of different wireless networks plus the servicing of dense urban, urban, inner rural, and outer rural areas as shown in FIGS. 4 and 5.

FIG. 4 is a graph of capacity requirement for communication networks are shown as a function of coverage area based on the type of area serviced. In this example, the coverage area varies from a dense urban area to outer rural area. Specifically, dense urban areas require the most network capacity because of the high number of users in this coverage area whereas outer rural areas require the least amount of network capacity and urban area and inner rural area require an intermediate amount of network capacity. However, because of the flexibility of the MSMNC system 100 that allows for the vRAN 300 to be quickly connected to a shareable base station tower in a rural area, the MSMNC system 100 allows for the extending of wireless services to rural areas that at present has been limited because of costs associated with extending known networks.

Turning to FIG. 5, a block diagram of a vRAN 500 used in a multi-dwelling unit or office 502 is shown. The multi-dwelling unit or office 502 may include three floors (for example) that each have a PoE switch 504, 506, and 508 and IoT, Wi-Fi, and/or CBRS terminal. The vRAN 500 is shown in signal communication with a customer-provided equipment (CPE) 510 that connects it to wireless front haul 512.

It is appreciated by those of ordinary skill in the art that in this disclosure, the RAN is a radio access network and is part of a mobile system. It implements a known radio access technology and resides between a device such as a mobile phone, a computer, or any remotely controlled machine and provides connection with its core network (CN). Depending on the nomenclature used in the relevant telecommunications standard, mobile phones and other wireless connected devices are varyingly known as user equipment (UE), terminal equipment, mobile station (MS), etc. In this disclosure, RAN functionality is typically provided by circuitry residing in both the core network as well as the user equipment.

The radio unit (RU) is a device, component, or module that that handles a RX/TX RF transceiver, digital front end (DFE) and parts of the physical (PHY) layer, as well as the beamforming functionality. In this example, a distributed unit (DU) sits close to the RU and runs the baseband (RLC, MAC) and parts of the PHY layer. In general, this logical node includes a subset of the base station, depending on the functional split option, and its operation is controlled by a centralized unit (CU). The CU runs the radio resource management (RRC and PDCP layers) and may be further sub-divided into CUCP for control plane functions and CUUP for user plane functions and data forwarding.

In this disclosure, the VRAN is configured to operate in combination with different base stations that include 5G wireless base states (known a gNB or gNodeB) that operate in licensed or unlicensed frequency bands that transmit and receive communications between the user equipment and the mobile network. It is appreciated that the use of the combination of RUs, DUs, and CUs, and gNB may be physically distributed throughout a communication network.

In this disclosure, a virtual radio infrastructure slice (known generally as a radio slice) is a shared resource part of the physical resources on a RU, Front haul and associated DU, CU, or antenna that can act as a base station, i.e., gNB. If the equipment can support multiple slices at once, the radio slices will be able to run mostly independent, secure, and isolated from each other. In addition to radio slices, the radio frequency bands can be divided and grouped into fully isolated spectrum slices of the frequencies where the spectrum slices can be divided into frequencies and time shared. In this disclosure, spectrum slicing is a part the communication resources available in that frequency band for radio signaling for the MMCS. For example, a spectrum slice may be part of a radio frequency band or it can also have other properties that distinguish it from other spectrum slices, such as modulation, beam-forming properties, or time slots.

Regarding radio slices, the MMCS utilizes a method and control apparatus to create a radio infrastructure slice virtualization that can dynamically handle the radio infrastructure slices. The radio slices can be created, deleted and/or changed in run-time without interference with other radio infrastructure slices. In this example, the radio infrastructure is the physical resources and the radio slices that are the virtual shared resources of the physical resources of radio hardware.

To manage these radio slices, the MMCS utilizes a radio infrastructure hypervisor that manages the radio slicing and schedules over the air (i.e., wireless) resources in the RAN, the radio infrastructure hypervisor can be integrated into the units of a RAN, the radio antennas, RU, distributed unit (DU), CU and fronthaul networks, to enable sharing of the radio infrastructure using the radio slice virtualization.

In general, the over the air radio resource sharing and radio slicing methods can differ for the different units. For example, FIG. 3 illustrates the virtual radio unit 304 connected through the virtual front haul network 306 to the virtual baseband unit 308 (i.e., DU). In this example, the radio unit, front haul network, and DU are shown as part of the vRAN 300 (integrated in a single unit) but it is appreciated that these units may be optionally geographically separated depending on the design of vRAN 300. In the case that all units are integrated, the virtual front haul network 306 may be reduced to internal interconnects. Some uses may have several DUs and virtual radio units 304 connected via the same virtual front haul network 306.

In this example, the radio units continuously transmit and/or receive signals on at least one frequency band. The radio infrastructure slices can use frequencies and/or time slots grouped together to a radio slice over contiguous and non-contiguous frequency bands for the transmitted and received spectrum. Thus, the signals from the various radio slices will be mixed in the radio units signal processing units but at the same time are isolated from a logical point of view. In the frequency domain, signals from different radio slices can be combined in contiguous or non-contiguous radio slices/carriers of data chunks, and in the time domain signals from one radio slice may be interleaved with signals from another radio slice to create more radio slices in the shared radio infrastructure. In this example, the mix of signals to/from different antennas can be used to simultaneously transfer signals of several radio slices. This handles the spatial dimension of radio slices.

The virtual front haul network 306 is commonly implemented as a packet switched ethernet network or as a millimeter wave high bandwidth network to carry the antenna data from the virtual radio unit 304 to the virtual DU/baseband unit 308. As an example, the virtual front haul network 306 may be implementation as an ethernet cable or optionally as a combination of switches or event IP routers.

The DU includes part of the baseband processing and other functionality needed in a complete gNB and may be integrated and collocated with the radio unit or separated. To enable radio infrastructure slicing, the computational, memory and other resources are handled in such a way that all radio infrastructure slices can be performed independently and isolated of other radio slices that run on the same equipment. In this example, a larger fraction of the signal processing on the DU may be performed in small batches with data belonging to a single radio slice. Therefore, several radio resources can be time shared in a fine-granular way among the radio slices. This includes, for example, forward error correction (FEC) accelerators, such as, LDPC transmitters and receivers, that can serve multiple radio infrastructure slices. Other resources such as CPUs, encryption engines may be both fine-grained time shared or simple allocated to different radio slices.

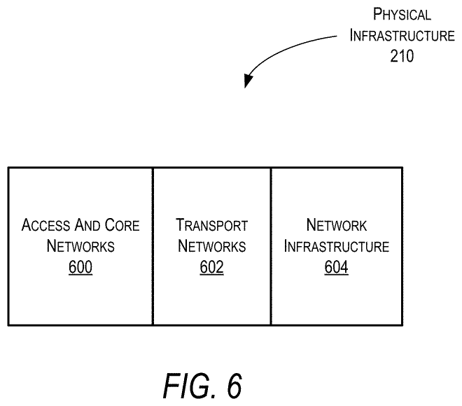

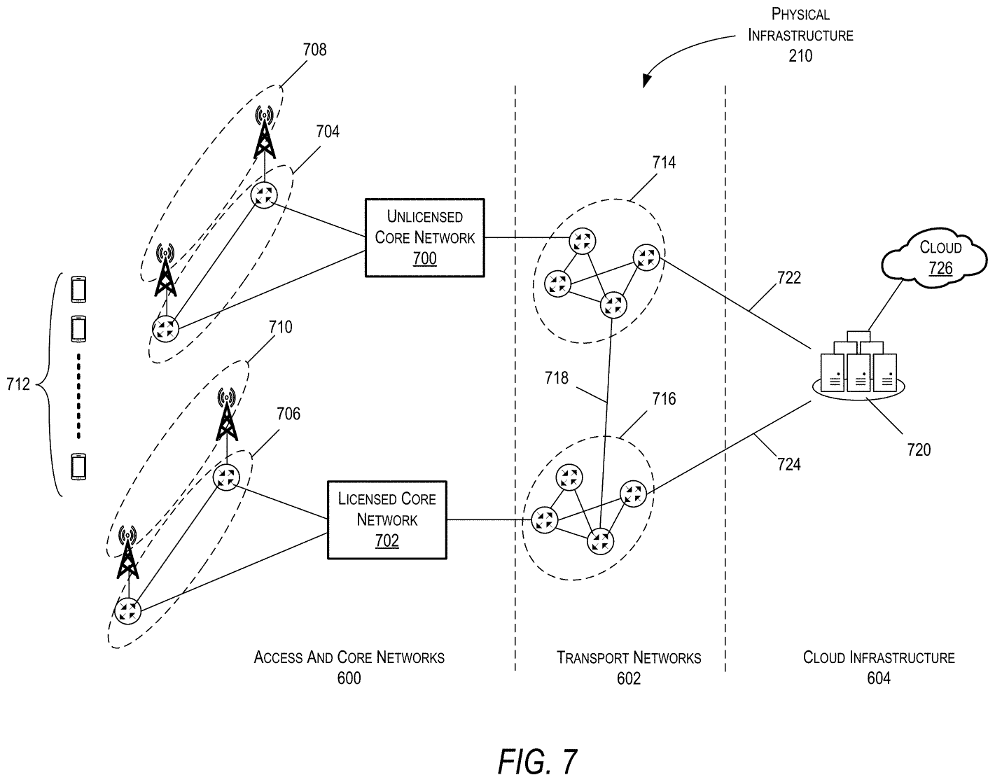

In FIG. 6, a system block diagram of an example of an implementation of the physical infrastructure 210 is shown in accordance with the present disclosure. In this example, the physical infrastructure 210 includes an access and core networks 600, transport networks 602, and network infrastructure 604. In FIG. 7, a system block diagram of an example of another implementation of the physical infrastructure 210 shown in accordance with the present disclosure. In this example, the access and core networks 600 include the unlicensed core network 700, licensed core network 702, switching elements 704 and 706, and base stations 708 and 710. The base stations 708 and 710 are in signal communication with one or more UE(s) 712.

The transport networks 602 includes an unlicensed network switching elements 714 and licensed network switching elements 716 where the unlicensed network switching elements 714 is in signal communication with the unlicensed core network 700 and the licensed network switching elements 716 is in signal communication with the licensed network switching elements 716. In this example, the unlicensed network switching elements 714 and the licensed network switching elements 716 may be in signal communication via signal path 718. The cloud infrastructure 604 may include a cloud server 720 that is in signal communication (via signal paths 722 and 724) with both the unlicensed network switching elements 714 and the licensed network switching elements 716 and the Internet 726.

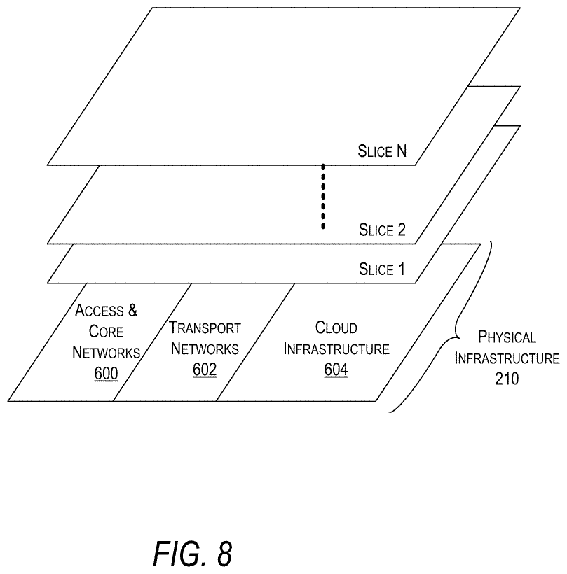

FIG. 8 is a system block diagram of an example of an implementation of virtual slices 1 through N of the physical infrastructure 210 of the vRAN 300 in accordance with the present disclosure.

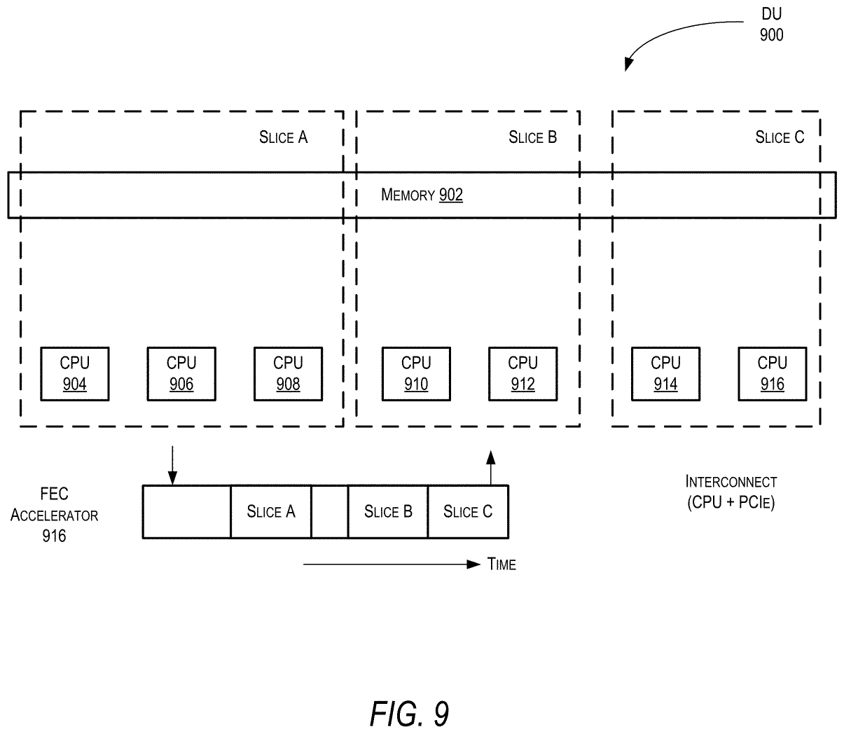

Turning to FIG. 9, an example of a system block diagram of a DU 900 with memory 902, CPUs 904, 906, 908, 910, 912, 914, and 914, and a FEC accelerator 916 as shown in accordance with the present disclosure. In this example, the dashed boxes indicate how the resources are allocated to radio slices (Slice A, Slice B, and Slice C).

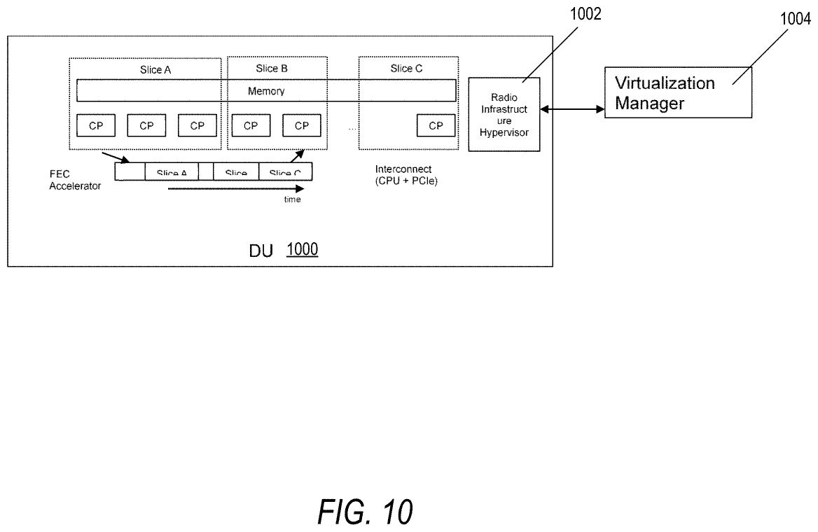

In this example, to fully utilize the shared radio infrastructure with the radio infrastructure slices, a virtualization mechanism is utilized to simplify the abstraction and use of the radio slices. The virtualization mechanism handles the allocation and de-allocation of resources (computational, memory etc.) in the equipment and dynamically (while other slices are used by RANs) provision new radio infrastructure slices. The radio virtualization mechanism optimizes the over the air radio resources and schedules them. In FIG. 10, the radio virtualization mechanism is shown as a virtualization manager in signal communication with the DU 1000 with a radio infrastructure hypervisor 1002. In this example, FIG. 10 shows the DU 1000 connected to a virtualization manager where the virtualization manager 704 has a connection to the radio infrastructure hypervisor 1002 located within the DU 1000. The radio infrastructure hypervisor 1002 is typically implemented in software and is configured to communicate with the virtualization manager 1004 over Internet Protocol.

In this example, the radio infrastructure hypervisor 1002 is configured to perform the following functions: keep record of all allocated and non-allocated resources in the DU 1000; allocate resources for a radio slice; deallocate resources from a radio slice; get and execute commands from the virtualization manager 1004; allocate a new radio slice with specific resources; allocate the radio slice; change radio slice resources (increase or decrease which includes both computational and spectrum resources); manage status requests; and inform the virtualization manager 1004 of the status of changes. The virtualization manager 1004 is configured to keep a record of all the units (RUs, DU, CUs) controlled by the virtualization manager 1004 and is part of/or connected to an Operations and Management (OaM) system for the provider of the radio infrastructure slices. The OaM is the system that controls, monitors, collect logs and provide the user the ability to affect the system (bring up, shutdown, resource planning etc.) The radio virtualization manager 1004 is also configured to optimize the over the air radio resources of the DU 1000 and schedules the air radio resources as needed.

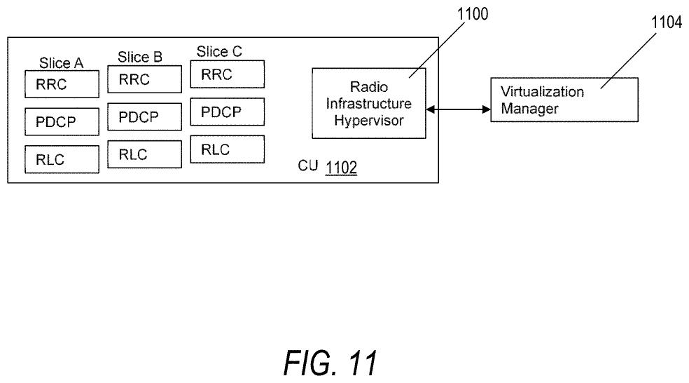

FIG. 11 is a system block diagram of an example of an implementation of the radio infrastructure hypervisor 1100 in CU 1102 and DU in accordance with the present disclosure. In this example, the radio infrastructure hypervisor 1100 is connected to the CU and DU protocol stack and the virtualization manager 1104. The radio infrastructure hypervisor 1100 is configured to handle the spectrum virtualization properties in the CU/DU/RU/antenna and keeps each allocated radio slice in the CU 1102 with the information needed to operate the CU and DU protocol stack for that particular slice. In this example, the RRC of slice A needs frequency information for its dedicated spectrum part of the radio slice, and the radio infrastructure hypervisor provides the information via configuration interfaces. The spectrum/ frequency information is also needed by the Scheduler in the DU as well as in the spectrum mixer connected between DUs and RUs, in our case running in the same machine as the DU.

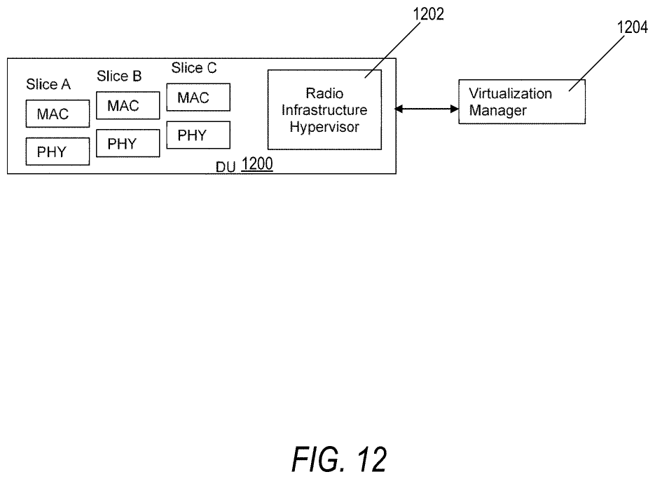

In FIG. 12, a system block diagram of an example of an implementation of DU 1200 with a radio infrastructure hypervisor 1202, three slices (Slice A, Slice B, and Slice C), and an external virtualization manager is shown in accordance with the present disclosure. Similar to CU 1102 example, in this example, the radio hypervisor 1202 provides the protocol stacks of the respective radio slices with information needed to operate within a radio slice. For example, a MAC scheduler is radio slice aware in the sense that it only allocates resource blocks (PRBs) that are allocated to the spectrum slice it operates within. In this example, the radio infrastructure hypervisor 1202 performs a method that separates the spectrum slices and this method may vary based on the design of the MMCS; however, in each case the spectrum slices operate in isolation.

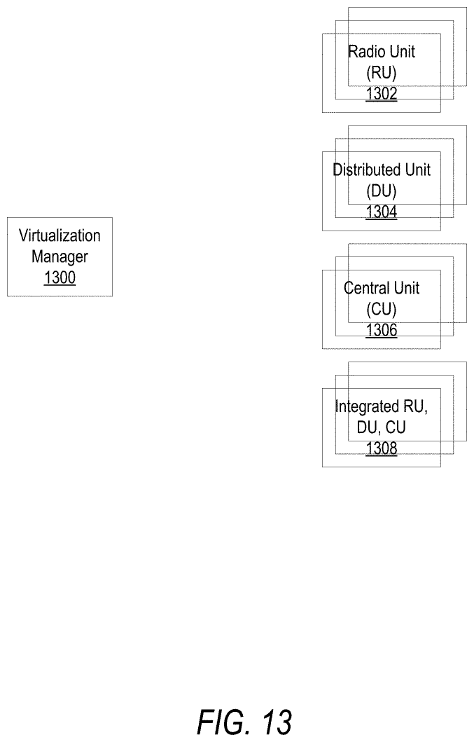

In FIG. 13, a system block diagram of an example of virtualization manager 1300 connected to multiple RUs 1302, DUs 1304, CUs 1306, and integrated RU-DU-CUs 1308 is shown in accordance with the present disclosure. In general, it is appreciated by those of ordinary skill in the art that a RAN is usually composed of many units such as RU, DU and CU. As such, the virtualization manager has connections to all units in a system to be able to schedule the radio resources and to have capabilities to share those in the radio slices where parts of a radio infrastructure slice may reside. In a shared RAN environment, the users are isolated per radio slice where each radio slice is associated with a tenant or end customers and it has its own users. As an example, the users that belongs to radio slice 1 cannot use the resources from other radio slices. In this example, is a user of a spectrum slice where the tenant may use all or parts of the available spectrum resources.

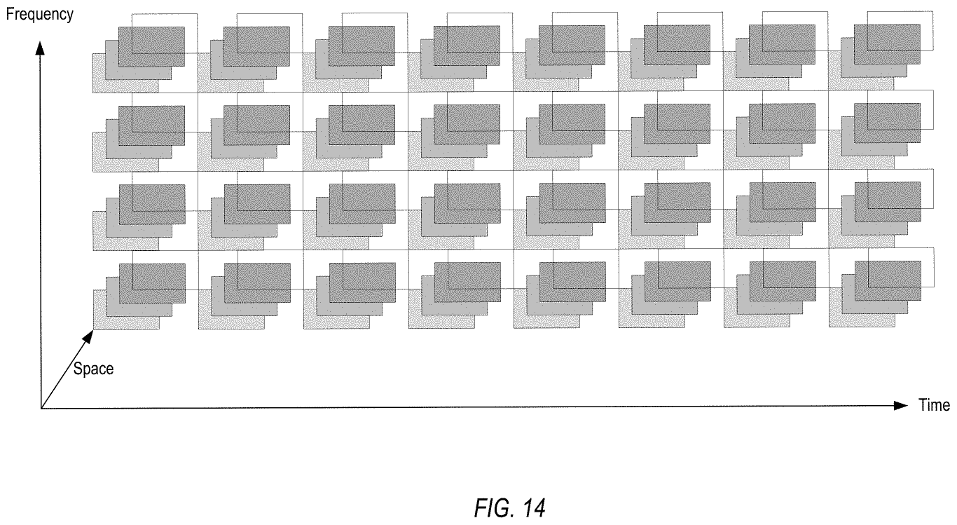

In FIG. 14, a system diagram of an example of an implementation of a plurality of spectrum resource managers connected the RUs and DUs to enable virtual spectrum slices in accordance with the present disclosure. In general, FIG. 14 describes the blocks that are the smallest spectrum resource. In this example, the frequency axis shows the total frequency band available for transmission and/or reception (TX/RX). This is for example the 5G band n79 or fraction thereof. As an example, for 5G, the unit is a physical resource block (PRB) which is 12 subcarriers wide (e.g., 15 kHz×12). The time axis shows the resource division in time. The length (time) is theoretically as short as an OFDM symbol but in usually it is longer. In this example, the space dimension indicates the spatial aspects of a multi-antenna system. These are the layers handled in a multiple-input and multiple-output (MIMO) system. The layers can mapped one-to-one to antennas but usually are mapped via virtual antenna ports and mixed to physical antennas. A code-book based or other beamforming method may be used. It is appreciated by those of ordinary skill in the art that in FIG. 14 the system diagram is only for an ease of illustration and that the system diagram may also include additional PRBs.

The spectrum slice is a part of the spectrum of a frequency band resources that can be used with limited interference from other spectrum slices for information transfer. Each spectrum slice is allocated a part of the total number of physical resources. FIG. 14 shows how the spatial, frequency and time slots are allocated to different spectrum slices, the different spectrum slices are indicated by different shaded boxes. Each spectrum slice contains the resources needed to act as a RAN independent of other spectrum slices—e.g., a spectrum slice for a 5G RAN includes resources for user data (PUSCH, PDSCH), control signaling (PUCCH, PDCCH), broadcast (PBSCH) and random access (PRACH) etc.

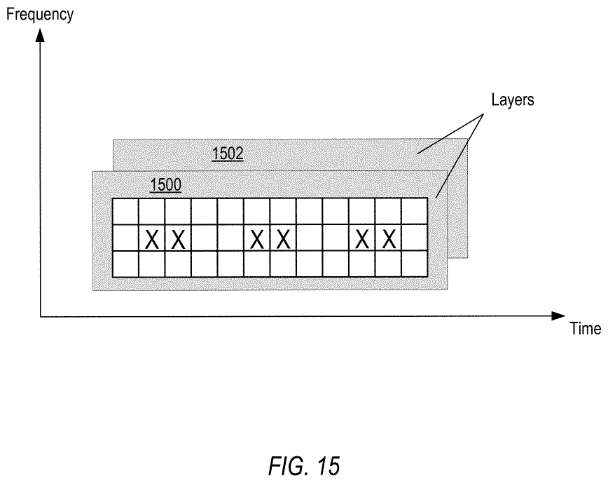

Turning to FIG. 15, a system block diagram of an example of an implementation of a virtual spectrum slice is shown in accordance with the disclosure. In this example, two layers of virtual spectrum slices 1500 and 1502 are shown, where the first virtual spectrum slice 1500 is shown to include a plurality of PRBs that are indicated by indicated by the X within the slice. In this example, the virtual slices 1500 and 1502 include a virtual spectrum slice ID and/or name, a start time, expiry time, repeat information, length, width, number of layers, and possible radio filter information. In this example, the repeat information is information about the virtual spectrum slice that is repeated until updated or expired. In this example, the repeat information can be used to reduce the amount of information need to send or store for a slot. With repeats, information I sent for the first slot in a grouping which is then repeated for slots occurring immediately after the initial slots. In virtual slice 1500 for example, there are six individual slots marked with an X, but the six slots are grouped in three groups consisting of slots in each group. Using repeat, only the first slot of each group needs to be described, transmitted, and stored, along with a repetition of two for each. In this way the number of information needed is nearly halved. Larger reductions are present when groups are larger, for example if there is a group of 10 adjacent slots, only information about the first slot needs to be described, transferred, and stored with a repeat factor of 9. It is appreciated that the virtual slices 1500 and 1502 may include additional information as need in the design of the slices.

The spectrum slice can be virtualized such that a tenant/user can use a spectrum slice without knowledge of the use of the other spectrum slices if the slice contains enough signaling resources. It can be used as, for example, a 5G RAN by its own without interfering with other RAN's.

To fully virtualize the spectrum a resource manager is needed, the spectrum resource manager may be generally referred to as a spectrum virtualization manager or spectrum curator. The resource manager must keep track of all available spectrum resources and enable automatic run-time configuration. As previously discussed, FIG. 10 illustrates the Spectrum resource managers connection to the RUs and DUs to enable virtual spectrum slices. This management interface is separated from the management interfaces provided by the RUs and DUs for the individual users of each spectrum slice.

In this disclosure, spectrum slicing allows multiple tenants to share radio signaling resources by virtualization of the spectrum slices. The spectrum slices can be allocated at run-time with limited interference with the RANs that already use other parts of the spectrum. Thus, a user may provision and bring up a RAN in parallel to the already running RANs with minimal interferences.

In this disclosure, the spectrum virtualization combined with radio Infrastructure slicing allows multiple tenants to share the same equipment for radio signaling. The tenants can use the same equipment and share the total transmission capacity but operate separate RAN's with minimal interference.

In general, the spectrum virtualization method of the present disclosure enables the multiple tenants/RANs to share frequency band resources fine-grained and dynamically and the flexible allocation of spectrum resources to/from a RAN depending on requirements etc. In general, the spectrum virtualization method is used in several steps. First, the tenant is allocated spectrum resources. These resources include: the antennas and corresponding radio sectors to use; what frequencies are allocated to the tenant; time sharing properties allocated to the tenant; MIMO/Beamforming parameters allocated to the tenant; and transmission power allocated to the tenant. Second, the allocated resources are provisioned by the RadiOS. The RadiOS will configure the equipment in order to run an isolated RAN with the allocated spectrum resources, where the RAN can later operate in isolation from other RANs utilizing parts of the same physical equipment. Third, the RAN is activated and maintained according to, for example, 3gpp and/or other applicable OAM systems and the spectrum resources allocated are kept isolated. Fourth, the spectrum virtualization parameters may be modified according to changed requirements and/or resource availability during the lifetime of the spectrum slice. For example, new antennas may be added/removed to change coverage, time sharing properties may change to increase/decrease RAN capacity, adjustments may be needed to handle environmental changes, e.g., a physical object changes the radio coverage, and interference from other transmissions may affect performance. Fifth, the spectrum virtual slice may be inactivated for a period of time for, for example, maintenance, temporary disturbances, or other high priority spectrum activity. Sixth, the spectrum resources are eventually released, making the resources available to other spectrum slices. As such, the virtual spectrum slicing technology described in the present disclosure enables the sharing of radio spectrum resources that allows slices to be used for independently managed RANs. This approach provides the ability to let several tenants/users run different RANs in parallel on the same frequency band with minimal interference. This approach also allows fine-grained time sharing and fine-grained dynamic allocation where, for example, virtual spectrum slicing would allow spectrum resources to be allocated to a slice within seconds and enable virtual spectrum slices share the same frequencies.

Again, in these examples, the radio infrastructure hypervisor is a device, component, or module that performs a method for dynamically controlling and managing the radio infrastructure slices. In these examples, the spectrum slices are created and fully isolated from a tenant (i.e., an end customer) where the radio slicing can be done to share the physical radio infrastructure among several tenants i.e., end customers.

As such, in this example, the spectrum virtualization method is a spectrum curation method that is a process of emulating a low-noise, highly available communication channel using a collection of communication channels which have time-varying and spatially varying levels of noise and availability. As a result, the spectrum curation method enhances the value of raw unlicensed spectrum and there are many potential mechanisms and steps to create this high quality of communication from the available various spectra, including steps related to analysis, modeling, provisioning, message division/multiplexing, transmission, message reconstruction, monitoring, correction/recovery, and adaptation.

In general, the spectrum curation method includes steps and assets that comprise raw spectrum inventory/asset management, spectrum aggregator, spectrum modeler, spectrum monitor, and channel monitor. In this example, the raw spectrum inventory/asset management includes: lists of available spectrum assets available to a node or node set; list of metadata about spectrum assets including time-varying data related to measurement of noise/interference; the ability to act as an inventory registry of spectra including the usage status of each channel on a fine-grained time scale, enabling multiple networks/tenants, etc., to intelligently and efficiently share spectrum; and ability to utilize a well-defined model of Spectrum, including geospatial attributes and interference attributes. The spectrum aggregator is configured to: consume (i.e., use as needed) spectrum Inventory assets and produce a synthesized radio channel; consume channel monitor to support decision on new synthetic radio channel allocation; support the creation of synthesized radio channels for multiple tenants—where (for security) each tenant has exclusive momentary use of a synthetic channel but tenants can share with time-based multiplexing or other means to optimally share assets; produce metadata on utilization of synthesized channel as well as utilization of underlying assets; and release spectrum assets back to inventory when no longer needed. The spectrum modeler is configured to model the performance and reliability of synthesized radio channels based on data from spectrum monitor and channel monitor; consume data from spectrum monitor; and recommends the composition of a synthetic radio channel based on available assets. The spectrum monitor is configured to monitor the usage and noise/interference of all physical radio channels/spectra at the node and synthesize a time and spatial noise model from point-observations. The channel monitor is configured to monitor the utilization of synthetic channels and provides data on throughput and headroom available for additional usage and is be utilized by the spectrum aggregator.

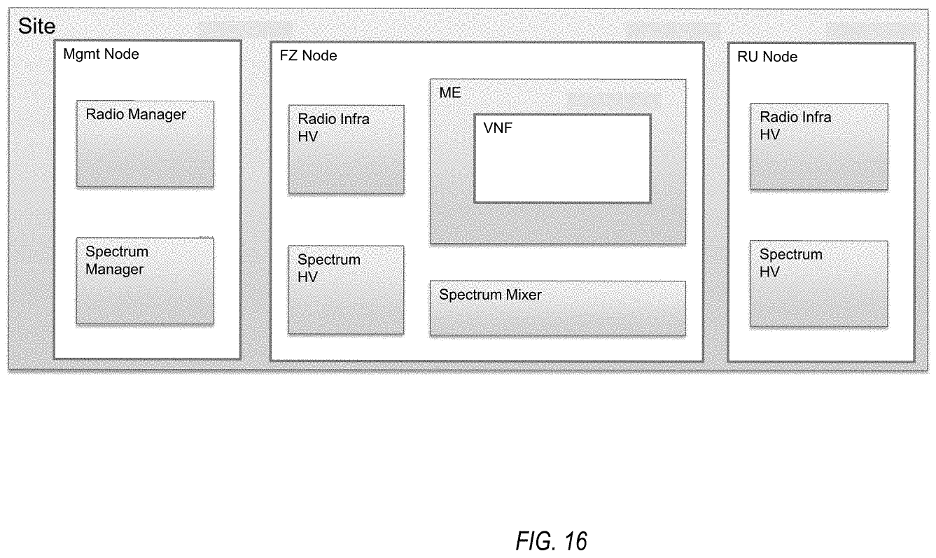

In reference to the following FIGS. 16-28, the following terms are defined as follows. A site—a site is a set of physical equipment that is located at a specified geographical location. An example of a site includes a radio, edge, and/or cloud site. A so called Frequencz (FZ) Node—a physical or virtual equipment that contains a radio hypervisor that include for example, a computer server, a virtual machine (VM) in the Cloud. A VM can be realized using a hypervisor and operating system virtualization, for example sharing multiple VM (workloads) on the same processor and the hypervisor schedules the VMs. Generally, a traditional hypervisor can run multiple operating systems such as Microsoft, FreeBSD and Linux. In this example, a “Container” means an “operating system virtualization.” The Container may be a process in Linux and similar to virtual machines it can run workloads and its Kubernetes that is the scheduler (hypervisor) of multiple containers sharing the same processor/compute hardware but, in this example, it only runs Linux as a virtualized operating system. A radio unit (RU) Node is physical radio equipment that contains antenna(s), radio transceivers, filters, amplifiers, associated computing and connectivity resources, etc. A Management Node is a Container for a Spectrum Manager, Radio Infrastructure Manager, etc. A Managed Equipment (ME) is a grouping of VNFs with management endpoint (3GPP) such as, for example, a group of VNFs with operational and configuration interfaces using command-lines (CLI) or machine-to-machine interfaces such that use XML or HTTP/REST technologies (such as NETCONF or RESTCONF). A Virtual Network Function (VNF) or Managed Function (MF) (3GPP) such as for example, a CU, DU, AMF, and/or UPF (The Evolved Packet Core (EPC) in 5G is disaggregated and user plane function (UPF) has been separated from the control plane functions in Packet Core such as SMF (for subscriber management) and AMF (for mobility management). UPF, AMF and SMF are VNFs (VM or container) running in the EPC on servers. The disaggregated design of UPF allow it to be distributed into the edge as well as and run in the mobile core which simplifies distribution of new edge functionality). A Radio Infra Slice is a set of MEs that span multiple sites and are managed as isolated network such as, for example, 5GC+5GRANs. An actor is a user role accessing the system with different credentials such as, for example, a Provider, Tenant, and/or Regulator, including government agencies such as the FCC, PTS and ECC. A Radio Infra HV includes software (SW) Supervising the hardware resources of the FZ Node or RU Node. A Spectrum hypervisor (HV) is a SW Supervising spectrum usage of the FZ/RU Node, typically connected to mixer and DUs. Mixing refers to the act of scheduling different requirement from different slices to the same physical radio media, in such a way that each slice gets its allocated slot and that no allocation of one slot disturbs the allocation of another. Mixing is made in frequency, space (direction), and time (slots) domains. A UE is User Equipment, Terminal such as, for example, a UE-SIM software simulator of a terminal, and/or actual physical terminals, such as a cellular telephone or a IoT device.

In this disclosure, the relations between system blocks are illustrated in the examples shown on the subsequent figures. In these examples, the equipment is located at various sites that may be radio sites with towers and antennas and an encapsulation for RUs, DUs power supply, etc. A site may also be an “edge” site that hosts servers and similar equipment. In this example, an edge site is a physical location between the radio equipment and a central location (such as a cloud site). A radio system could be sensitive to latency and thus over the air interference and retransmissions and latencies to the core site, which means that all equipment often cannot be placed in a central location. If that is the case, an edge site will improve the latency for latency sensitive applications such as AR/VR/gaming/industrial applications. In the edge, host equipment which is sensitive to latency needs to be distributed to improve the overall latency and needs to be close to the radio equipment while at the same time provide some aggregation. The third type of site is a cloud site, which is a centralized location with a high degree of aggregation, where general-purpose computing equipment is placed, and where virtualization can be employed to increase the time and spatial sharing of resources. Applications such as EPC, billing, user/device authentication hosted in the cloud site are normally not real time critical. Such sharing of resources is performed by cloud-software and are typically hosted as a service supplied by cloud companies. In this example, although an exact location of such cloud site may be less well defined, generally, it is a place where certain functions may be run and connected to other sites over IP. The management node is a block that can contain the management functions such as the Virtual Spectrum manager or the Radio Infra Manager. The site is usually a cloud site but can be located at any node with sufficient computing, storage, and reliability capabilities. Most systems would only have a single management container per provider, unless, for example, for redundancy.

The FZ Node is central to the actual per radio infrastructure slice as the VNFs of 3GPP and/or 5G etc. runs here. Generally, each FZ Node needs a Radio Infra Hypervisor to control its physical resources such as CPU, memory and codec accelerators. The FZ Node can also contain a virtual spectrum hypervisor if the nodes operation is dependent on the virtual spectrum of any of the slices that use the FZ Nodes resources. The ME(s) (Managed Element) within the FZ Nodes refers to the 3GPP specified ME containing one or many radio application VNFs, such as a RU, CU, DU, AMF, SMF or UPF. In these examples, the RU Node is the radio unit. The RU Node is managed from a Radio Infrastructure Manager and does not contain a ME as is generally configured is a slave under a DU or CU. The radio node may be located near power amplifiers and antennas or integrated RU with built-in antennas or RUs with DAS (Distributed Antenna Systems).

FIG. 16 is a block system diagram of an example of implementation of a site in accordance with the present disclosure. The site includes a management node, FZ node, and RU Node. IN this example, the management node includes a radio manager and a spectrum manager. The ME includes an VNF. The FZ Node includes a ME, radio infrastructure hypervisor (HV), spectrum HV, and spectrum mixer. The RU Node includes a radio infrastructure hypervisor and spectrum hypervisor.

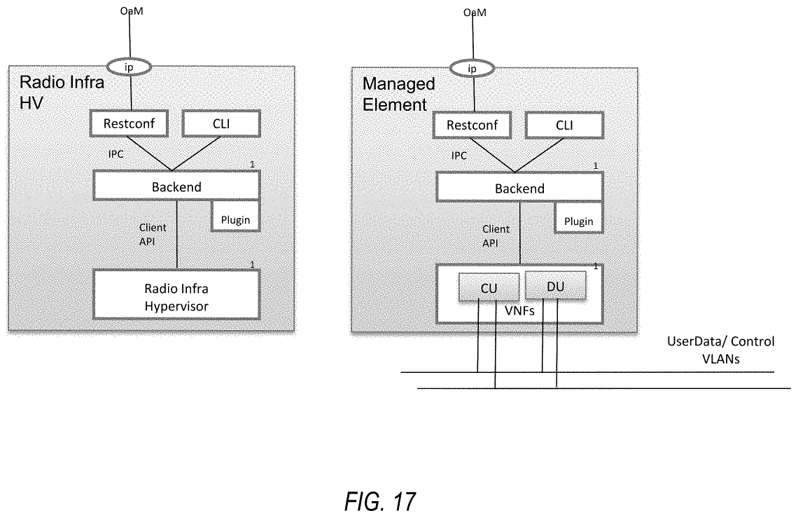

FIG. 17 is a block system diagram of an example of an implementation of radio infrastructure hypervisor and managed element shown in FIG. 16 in accordance with the present disclosure. The internal radio infrastructure hypervisor structure is as follows: The main functionality is implemented by a radio infrastructure hypervisor process that manages the resources of the nodes, accessed for operations and maintenance (OaM) via an addressable IP interface to a RESTCONF configuration entity, or directly via a command-line interface (CLI) to a configuration backend that relays configuration messages over an internal client API.

The Managed element includes one or more VNFs, backend, plugin, reconf, and CLI. The one or more VNFs each include a CU and DU.

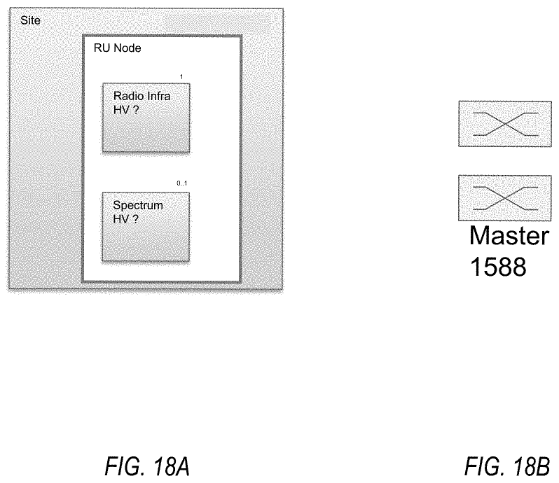

FIG. 18A is a block system diagram of an example of an implementation of a site with a fronthaul and RU in accordance with the present disclosure. The site includes a RU Node that may include a radio infrastructure hypervisor and a spectrum hypervisor.

FIG. 18B is a block system diagram of an example of an implementation of a Master 1558 in accordance with the present disclosure.

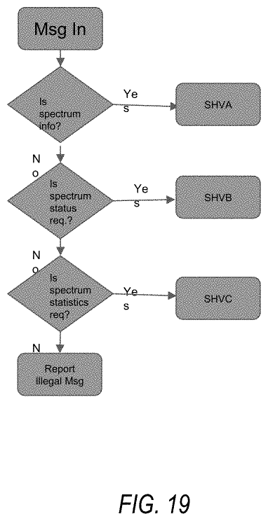

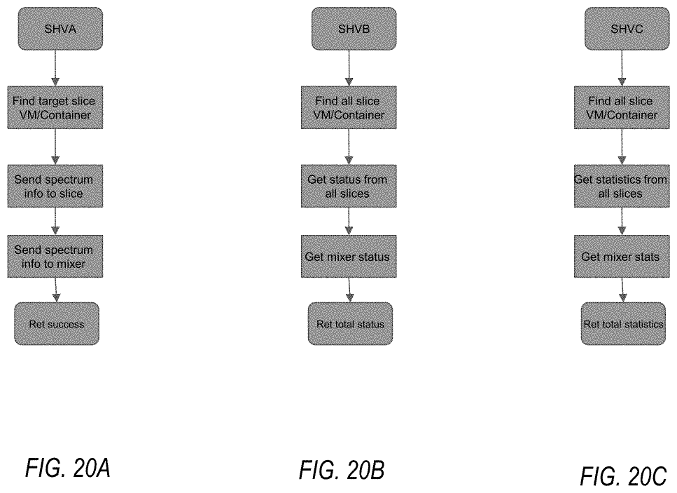

With regard to FIGS. 19 through 20C, a spectrum hypervisor (HV) is described. In these examples, the spectrum hypervisor (SHV) is the endpoint in the FZ Node that the virtual spectrum manager (VSM) communicates with. The VSM sends control and virtual spectrum information to the SHV and the SHV forwards this information to the units in the FZ Node that need it for proper operation within its spectrum slice and avoid spectrum collision. In general, the messages include input message that include spectrum information, status of the spectrum, and statistics of the spectrum. The spectrum information includes a slice ID and information that specifies the spectrum information as matrices. In this example, each element is 1 or 0 and the PRBs can be allocated by infrastructure slice or not. The spectrum information also includes Expiry time, repeat information, and start time. The status of the spectrum includes status for the slices on the node and the statistics of the spectrum includes statistics for the slices of the node.

FIG. 19 is a flowchart of a method performed by a spectrum hypervisor in accordance with the present disclosure. The method starts with a message input. The method determines if the message has spectrum information. If so, it sends this information to the SHVA. In this example, SHBA, SHBB, and SHBC are names of sub-flowcharts described in more detail in FIGS. 20A-20C. SHVA is the start of the first of three sub-flowcharts in FIG. 20A-20C. If no, the method determines if the message has spectrum status information. If so, it sends this information to SHVB). If no, the method determines if the message has spectrum statistics information. If so, it sends this information to SHVC. If no, the method reports an illegal message signal.

FIG. 20A is a flowchart of a method performed by a spectrum hypervisor in accordance with the present disclosure. In these examples, SHVA, SHVB, and SHVC represent the different message inputs as described in FIG. 19: SHVA for setting spectrum information; SHVB for getting spectrum status (on/off status of the spectrum mixer components); and SHVC for getting spectrum statistics such as counters. In this example, the method performed by the spectrum hypervisor (described in FIG. 19) determines that message has spectrum information and passed it to the SHVA. The method then finds a target slice VM/Container, sends the spectrum information to the slice and spectrum mixer and resulting in a success of the operation which is relayed back to the initiator client of the operation.

FIG. 20B is a flowchart of a method performed by a spectrum hypervisor in relation to the SHVB in accordance with the present disclosure. In this example, the method performed by the spectrum hypervisor (described in FIG. 19) determines that message has spectrum status information and passed it to the SHVB. The method then finds all slice instances, retrieves the status from all the slices, retrieves spectrum mixer status, and produces a result status indicating whether the components in the slice are up and running in a normal state or not.

FIG. 20C is a flowchart of a method performed by a spectrum hypervisor in relation to the SHVC in accordance with the present disclosure. In this example, the method performed by the spectrum hypervisor (described in FIG. 19) determines that message has spectrum statistics information and passed it to the SHVB. The method then finds all slice instances, retrieves the statistics from all the slices, retrieves the mixer statistics, and produces a message consisting of all statistics in the slices (such as counter values) and returns to the initiator client.

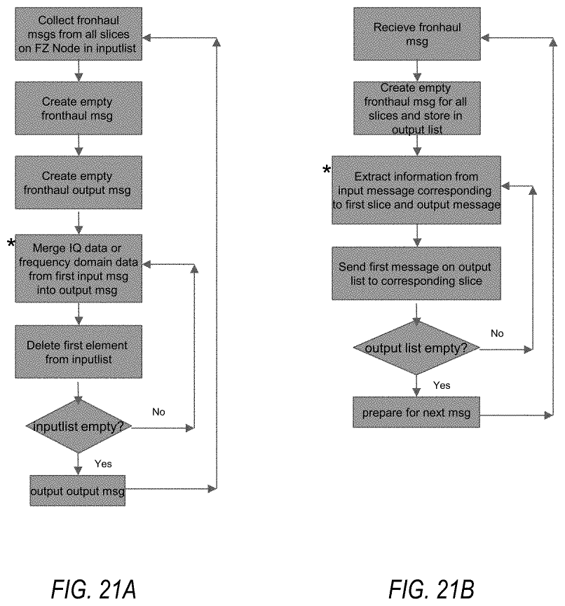

FIG. 21A is a flowchart of a method performed by a flowchart mixer utilizing fronthaul messages from infrastructure slices of a DU in accordance with the present disclosure. The mixer operation in the fronthaul between the DU and the RU. That is, the spectrum mixer mixes spectrum information from several DU instances, each located in a separate slice, and produces a common spectrum information that is sent to a single shared RU. The mixer generally runs in the FZ Node but could potentially also be in the RU in case the DUs are not co-located to the same FZ Node. The Mixer handles the multiplexing/demultiplexing of the virtual spectrum signals from multiple DUs in the system. In this example, the DUs may be allocated to different radio infrastructure slices that use different virtual spectrum. Thus, the signals should be mixed if they are to be transferred on the band of a single radio. The signals may be interleaved timewise, added to adjacent frequencies or different MIMO layers, according to the virtual spectrum information.

The method includes collecting fronthaul messages from all slices on the FZ Node in the inputlist. In this example, an inputlist in this context is a list of slice instances from where information is collected. A user of the method can choose to collect information from a subset of slices and can construct an inputlist that consists of exactly those slices. The method then creates an empty fronthaul message, empty fronthaul output message, and merges IQ data or frequency domain data from the first input message into the output message. The message then deletes the first element from the inputlist and determines if the inputlist is empty. If not, the method returns to merging the IQ or frequency domain data and repeats. If yes, the method outputs the output message and returns to collecting the fronthaul messages and repeats until the inputlist is empty.

FIG. 21B is a flowchart of a method performed by a flowchart mixer utilizing fronthaul messages to infrastructure slices of the DU in accordance with the present disclosure. In this example, the method receives the fronthaul message and creates an empty fronthaul message for all the slices and stores them in the output list. The method also extracts information from the input message corresponding to the first slice and output message and sends the first message on the output list to the corresponding slice. The method then determines if the output list is empty. If the output list is not empty, the method repeats extracting the information from the input message and the other steps. If, instead, the output list is empty, the method prepares for the next message and repeats the step again beginning with the receiving the fronthaul message.

In these examples, there a few assumptions that include that all slices produce (i.e., output) the same format fronthaul messages, slices output the same length (i.e., start time to end time) messages, all slices are configured to use the same type of RRU, all slices are configured for the same frame patterns UL/DL, and all slices should use non-overlapping PRBs, otherwise error. The merge and extract operations (marked*) operate based on the virtual spectrum information received from the spectrum hypervisor. The operation may be parallel for performance. Impl depends on Radisys code, may differ from standardized frame formats, for example such as defined by the O-RAN alliance where Open RAN/ORAN is an industry consortium for 5G.

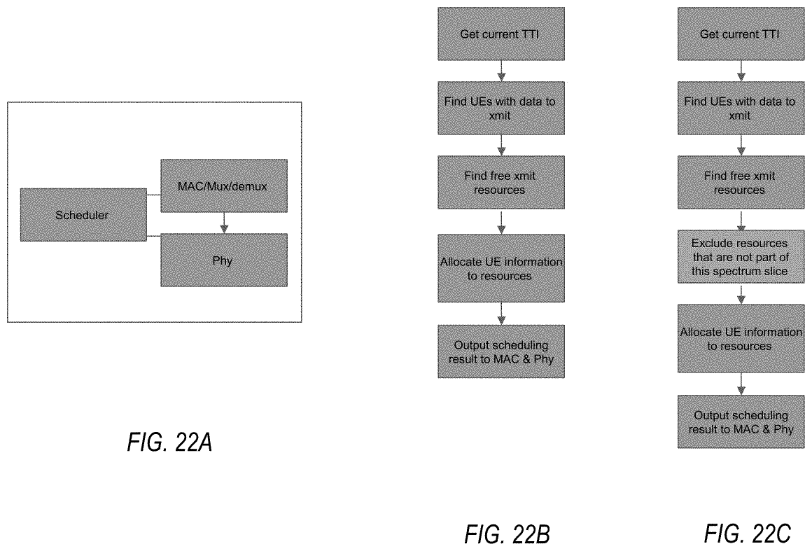

FIG. 22A is a system block diagram of a part of a DU related to a scheduler and physical layer in accordance with the present disclosure. The DU includes the scheduler, MAC, Multiplexer (Mux), or demultiplexer (demux), and a physical layer. In this example, the scheduler is responsible for allocating UL/DL resources for transmission and communicates with the 5G MAC and the physical layer to optimize the transmission. The MAC, Mux, or demux get information from the scheduler to pack/unpack data and control signaling. The Physical layer is responsible for coding the information in a form suitable for transmission and reporting back decoding success and failure. The scheduler considers all relevant configuration data, transmission channel properties, re-transmission requests (HARM) etc. to schedule data for UL and DL each TTI (time interval). The enhancement to enable spectrum virtualization is a mechanism in the scheduler that prevents the use of certain resources. These may be used by other radio infra slices. In this example, the scheduler runs repeatedly for each TTI.

FIG. 22B is a flowchart of a method performed by a schedular in accordance with the present disclosure. The method obtains current TTI, finds UEs with data to transmit, and finds free transmitter resources. The method also includes allocating UE information to the resources and outputting the scheduling result to the MAC and physical layer.

FIG. 22C is a flowchart of a method performed by the schedular with virtual spectrum slice support in accordance with the present disclosure. The method gets the current TTI, finds UEs with data to transmit, finds free transmitter resources, and excludes resources that are not part of this spectrum slice. The method also includes allocating UE information to resources and outputting the scheduling result to MAC and physical layers.

In these examples, there are some additional assumption with regard to the virtual spectrum manager. These assumes include the Virtual Spectrum Manager runs in cloud (AWS), the VSM has access to the OaM interface (restconf) of all the Virtual Spectrum Hypervisors (VSHs), and the VSM continuously collects and records spectrum use data from the Radio infra slices. The spectrum use information is currently primarily collected by reading state data from the VSHs restconf and reading syslog entries originating from the VSHs and fronhaul/eCPRI mixers on the FZNodes. Another assumption includes that problems may be reported by VSHs asynchronously to the VSM using the restconf/clixon notify mechanism. Example, two infra slices that attempt to transfer data on the same spectrum resources.

In operation in these examples, the VSM starts when the provider decides to bring up the services. Generally, it should be kept online/up for as long as the provider intends to provide VPRs to the tenants. The data store and processing are separated to enable restart without data loss.

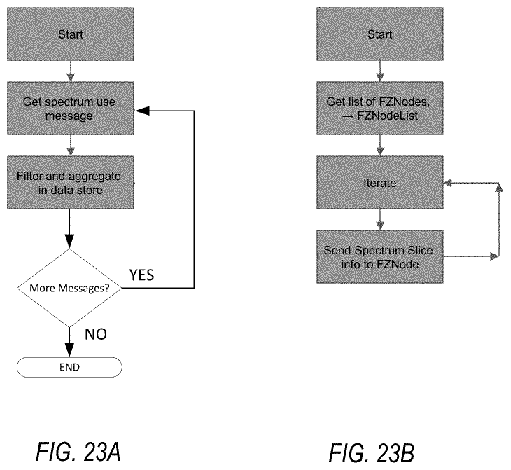

FIG. 23A is a flowchart of a method performed by the virtual spectrum manager for a spectrum use collection process in accordance with the present disclosure. The method starts by obtaining a spectrum use message and then filters and aggregates the spectrum use message into a data storage. The method then repeats buy obtaining a new spectrum use message and repeating. The method ends when there are no more spectrum use messages. In this example, the data to be stored may be aggregated spectrum usage data and/or OaM handles to all radio hypervisors where SHVs are may be accessed via individual RHVs.

FIG. 23B is a flowchart of a method performed by the virtual spectrum manager for a spectrum distribution process in accordance with the present disclosure. The method starts by obtaining a list of FZ Nodes, which defines the destination of the spectrum information, and send the spectrum slice information to each individual FZ Node. The method then repeats by iterating the list of FZ Nodes and sending the spectrum slice information. The loop ends when administratively stopped, that is, when the initiating client stops the process.

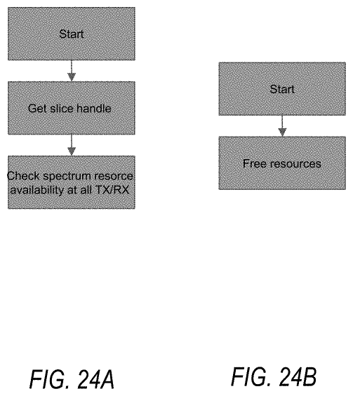

FIG. 24A is a flowchart of a method performed by the virtual spectrum manager for an allocation new spectrum slice process in accordance with the present disclosure. The method starts by obtaining a slice and continues to check the spectrum resource availability of at all of the transmitters and/or receivers.

FIG. 24B is a flowchart of a method performed by the virtual spectrum manager for delete spectrum slice process in accordance with the present disclosure. In general, the method starts by determining free spectrum resources, that is available spectrum that can be used by the slices.

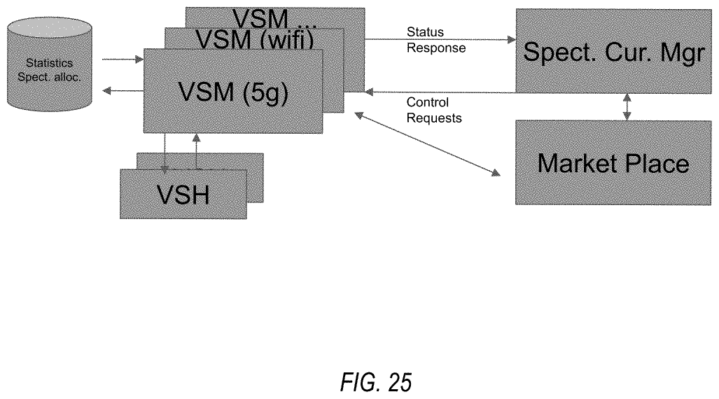

FIG. 25 is a system block diagram of an example of an implementation of the virtual spectrum manager in accordance with the present disclosure. The system includes a storage database with statistical and spectrum allocation data for the slice), a plurality of VSMs, a spectrum curation manager, a plurality of VSHs and a market place. In this example, the individual VSMs may correspond to, for example, Wi-Fi, 5G, etc. The spectrum curation manager is configured send control request to and receive status responses from the individual VSMs. The market place is also configured to provide and receive control requests to the individual VSMs. The signals going back and forth between the storage database and the VSMs are primary get and set functions, such that retrieve and store statistics and spectrum allocation information. The VSM controls the VSHs using messages for configuration and retrieves status and statistical data messages from VSHs to VSM in order to perform analytics operations in VSM.

In this example, the individual VSMs are responsible for distributing virtual spectrum to VSH; tracking changes in spectrum assets, e.g., new RU, towers, antennas; tracking coverage based on frequency, space (MIMO) properties, 5g numerology, bandwidth part (5G BWP); recording of spectrum statistics; keeping record of resources allocated per radio infra slice; and collecting statistics from all VSHs regarding spectrum coverage, use, and utilization coverage. The utilization over the air coverage includes areas covered by part of spectrum and quality of service (QoS) achieved, that is, to what extent the spectrum allocation was successful in term of actual bandwidth, latency, etc. of the traffic transferred between DU, radio and UEs. The statistics also include how the spectrum is used, sporadic or continuously, high/low between utilization and how much is used.

The relationships between the plurality of VSM to the spectrum curation manager allow for the allocation of aspects of the virtual spectrum slice that includes: frequency band; requested bandwidth, UL/DL ratio; requested technology such as 5G, Wi-Fi, etc.; requested coverage, antenna list, geographical coverage per antenna (such as at a tower), and requested QoS. The spectrum curator manager is also configured to allow for deallocation and obtaining statistics.

In these examples, the radio infrastructure hypervisor (RHV) runs on every physical node of the system. This includes nodes for CUs, DUs, and RUs. The RHV contain processes for handling: incoming messages from the Radio Infrastructure manager over the restconf interface; supervision of all VMs/containers on the node and functions for notification for alarms etc.; status and statistics reporting using restconf; and monitoring and forwarding syslogs to cloud. In this example, the notifications can be sent using different technologies, such as SNMP, RESTCONF or NETCONF which are examples of standards. Examples of implementation include VMs, Containers, and/or Kubernetes. In these examples, the messages currently include create, delete, change resources, and status requests.

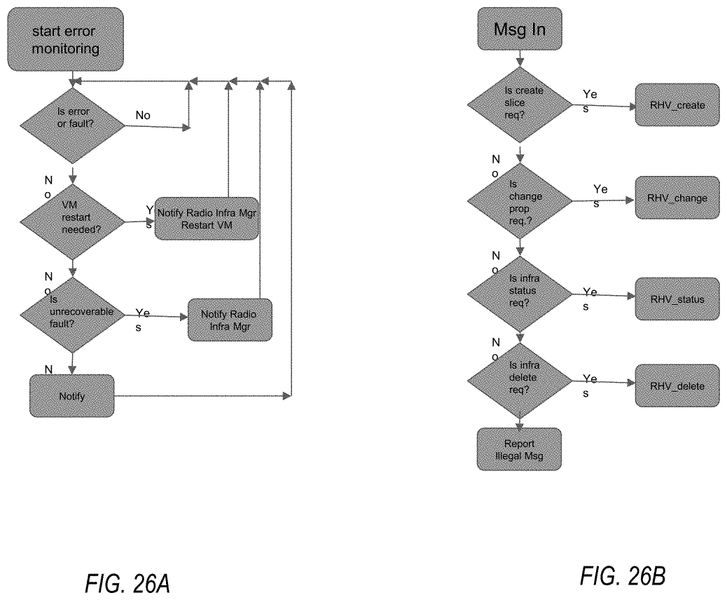

FIG. 26A is flowchart of a method performed by the radio infrastructure hypervisor for delete spectrum slice process in accordance with the present disclosure. The method starts error monitoring and determines if there is an error or a fault. If there is an error or fault, the method determines if a VM needs to be restarted. If no, the method determines if there is an unrecoverable fault. If no, the method notifies the Radio infrastructure hypervisor which in turn can perform some mitigation actions such as restarting the VM.

If there is an unrecoverable fault, the method notifies the radio infrastructure manager and returns to determining if there is an error or fault. If the VM needs to be restarted, the method notifies the radio infrastructure manager, restarts the VM, and returns to determining if there is an error or fault. If there is no error or fault detected, the method continues to monitor for errors and faults.

In this example, the input message may include message to create an infrastructure slice with initial property, change the infrastructure slice property, delete the infrastructure slice, or provide status and logging.

FIG. 26B is flowchart of another method performed by the radio infrastructure hypervisor for delete spectrum slice process in accordance with the present disclosure. The method receives an incoming message and determines whether a slice needs to be created. If yes, the radio hypervisor (RHV) creates the message. If no, the method then determines if a change in property is needed. If yes, the RHV performs the change. The method then determines if an infrastructure status is needed. If yes, the RHV produces a status whether the components that constitute the RHV are running or not. If no, the method determines if the infrastructure needs to be deleted. If yes, the RHV deletes the infrastructure, such as removing VMs that constitute the RHV. If no, the method reports an illegal message.

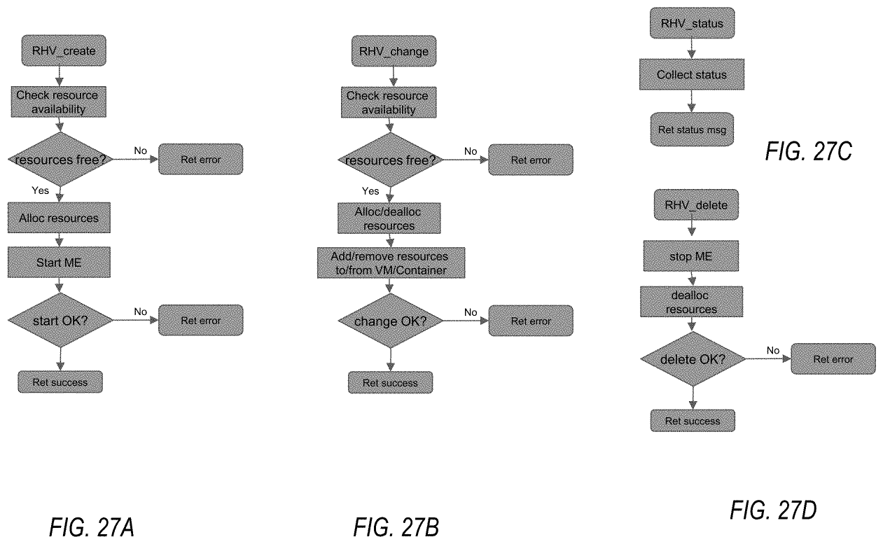

FIG. 27A is flowchart of yet another method performed by the radio infrastructure hypervisor for delete spectrum slice process in accordance with the present disclosure. The method starts when the previous method described in FIG. 26B determines that a slice needs to be created. The method then checks for resource availability and determines if the resource is available. If no, the method produces a return error. If the resources are available, the method allocates the resources and starts the ME. The method then determines if the start of the ME is acceptable. If no, the method produces a return error. If yes, the method returns return message indicating that the ME startup was a success.

FIG. 27B is flowchart of still another method performed by the radio infrastructure hypervisor for delete spectrum slice process in accordance with the present disclosure. The method starts when the previous method described in FIG. 26B determines that a change in property needs to be done.

The method then checks for resource availability and determines if the resource is available. If no, the method produces a return error. If the resources are available, the method allocates or deallocates the resources. The method then adds or removes resources to and from the VM or Container. The method then determines if the change is acceptable. If no, the method produces a return error. If yes, the method returns return message indicating that the change was a success.

FIG. 26C is flowchart of another method performed by the radio infrastructure hypervisor for delete spectrum slice process in accordance with the present disclosure. The method starts when the previous method described in FIG. 26B determines that an infrastructure status is need. The method then collects the status and returns a status message.

FIG. 26D is flowchart of yet another method performed by the radio infrastructure hypervisor for delete spectrum slice process in accordance with the present disclosure. The method starts when the previous method described in FIG. 26B determines that the infrastructure needs to be deleted. The method stops the ME, deallocates the resources, and determines if the change is acceptable. If no, the method produces a return error. If yes, the method returns return message indicating that the change was a success.

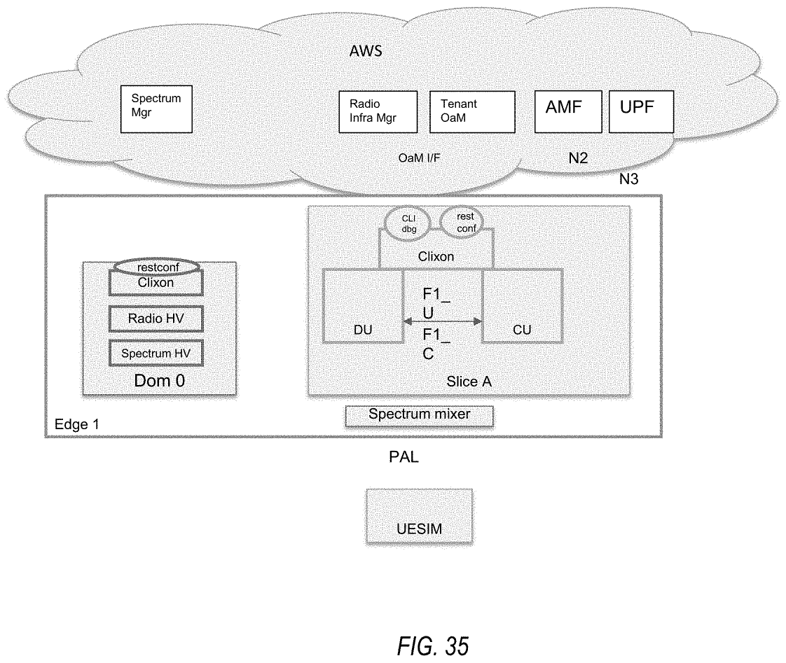

FIG. 35 is a block diagram of an edge plus cloud site in accordance with the present disclosure. In this example, the system is shown communicating with two tenants (tenant A and B) and a provider. The system includes a cloud site and backhaul that includes edge site 1 and radio site 11. The Cloud site includes a management node and a FZ node. The FZ node include a first GUI corresponding to tenant A, a second GUI corresponding to tenant B, and a ME slice A having an UPF/AMF/SMF, which are packet-core VNFs. The management node includes a radio manager and spectrum manager.

The edge site 1 includes a FZ Node having a radio infrastructure HV, spectrum HV, ME slice A, ME slice B, and spectrum mixer. The ME slice A includes a CU and DU and the ME slice B includes a UPF/AM and F/SMF and a CU/DU. The radio site 11 includes a RU Node. The provider OAM ensures connectivity and management for the provider actor to all system components in the system, including connectivity over the backhaul in the upper part of the figure as well as over the fronthaul in the lower part of the figure. Data transfer over the fronthaul, such as between the spectrum mixer and the radio nodes can run over a standard packet switched network using some standardized framing, such as “eCPRI.”

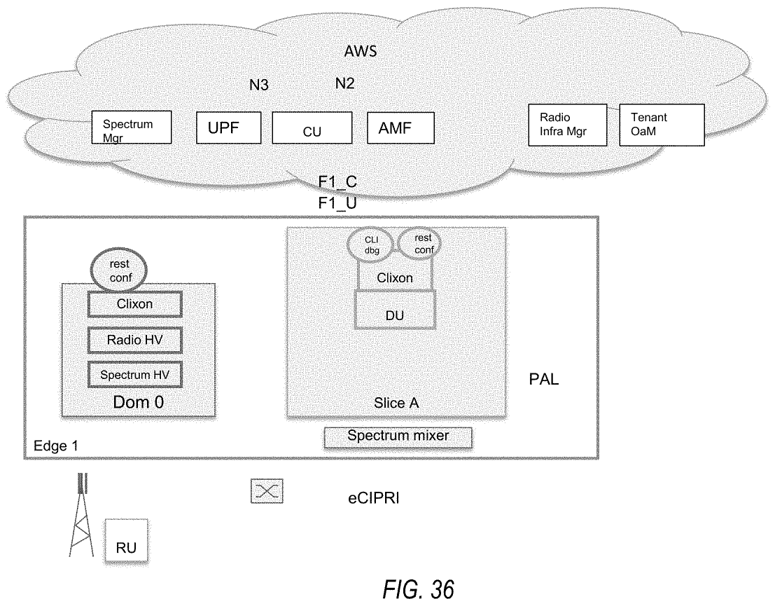

FIG. 36 is a system block diagram of an example of an implementation of an infrastructure slice, spectrum mixer, and radio hypervisor at a centralized unit and distributed unit at an edge site in accordance with the present disclosure.

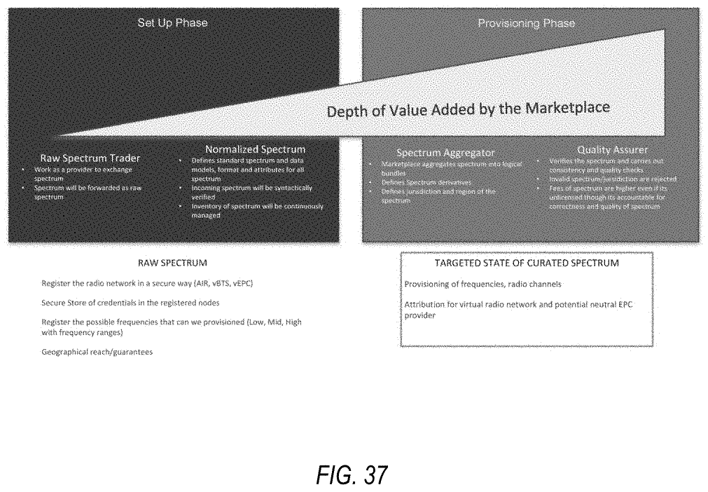

FIG. 37 provides another more detailed functional diagram further describing how the spectrum marketplace is implemented allocated spectrum. The virtual spectrum manager has been disclosed and described in detail in the previous sections of this disclosure. The spectrum curation manager has the role of providing the channels available for use by the tenants. Spectrum curation is the process of emulating a low-noise, highly available communication channel using a collection of communication channels which have time-varying and spatially varying levels of noise and availability. This has the effect of foundationally enhancing the value of raw unlicensed spectrum by improving its quality for the tenant. There are many potential mechanisms and steps to create this high quality of communication from the available various spectra, including steps related to analysis, modeling, provisioning, message division/multiplexing, transmission, message reconstruction, monitoring, correction/recovery, and adaptation.

Spectrum curation by the spectrum manager comprises the following method steps in conjunction with the enumerated physical assets. The first step is to provide raw spectrum Inventory for asset management comprising the following sub-steps: (1) collects and lists available spectrum assets available to a node or node set; (2) collects and lists metadata about spectrum assets including time-varying data related to measurement of noise and/or interference; (3) conducts inventory registry of spectra including the usage status of each channel on a fine-grained time scale, enabling multiple networks/tenants etc. to intelligently and efficiently share spectrum; and (4) models the spectrum using a Spectrum Modeler to include geospatial attributes and interference attributes, among other parameters.

The spectrum modeler models the performance and reliability of synthesized radio channels based on data from Spectrum Monitor and Channel Monitor. The spectrum modeler inputs data from Spectrum Monitor and recommends the composition of a synthetic radio channel based on available assets. The spectrum monitor performs the function of collecting the usage and noise/interference data from all physical radio channels/spectra at the node and then synthesizes a time and spatial noise model from point-observations. The channel monitor monitors the utilization of synthetic channels and provides data on throughput and headroom available for additional usage.

The second step is to provide spectrum aggregation comprising the following sub-steps: (1) manages and allocates spectrum inventory assets and produces a synthesized radio channel; (2) uses the channel monitor to support decision on new synthetic radio channel allocation; provides for the creation of synthesized radio channels for multiple tenants where each tenant has a secure and exclusive momentary use of a synthetic channel based on predetermined security needs; (3) distributes to tenants needed assets and resources with time-based multiplexing or other means to optimally share assets; (4) outputs metadata on utilization of synthesized channel as well as utilization of underlying assets; and (5) releases spectrum assets back to inventory when no longer needed by tenants.

In this example, the spectrum curation process is used to turn raw unlicensed spectrum into high quality spectrum to use or share. Spectrum management is bifurcated into (1) a set-up phase and (2) a provisioning phase as shown. The set-up phase comprises the trading of raw spectrum and the normalization of spectrum.

The trading of raw spectrum is conducted by a spectrum trading auction algorithm. Anything deemed of value can be used in the trading of spectrum, including, for example, the following: exchanging government currencies for spectrum; exchanging one part of the spectrum for another, more desirable, slice of spectrum; exchanging decentralized digital currencies for spectrum, such as, for example, with Bitcoin; and registering tenants and providers in a privately managed spectrum exchange operator, similar to trading on a stock exchange. The trading of spectrum is conducted using auction algorithms that are well known to those of ordinary skill in the art. For example, auction algorithms are discussed in detail by Dimitri P. Bertsekas in Auction Algorithms for Network Flow Problems: A Tutorial Introduction, Computational Optimization and Applications, 1, (1992), 7-66, Kluwer Academic Publishers. In one embodiment, the regulator has the role and responsibility for spectrum trading. This regulator can be a government agency, or a private entity contracted by the government. In another embodiment, a private entity operating a network can fill this role. Regardless of the nature of the entity, the role of the regulator is to arbitrate conflicts for the use of any of these spectrum frequencies and for using the market to allocate spectrum.

Another attribute of the set-up phase is the registration of radio networks using secure means, such as, for example, AIR, vBTS and vEPC. Another attribute is storing security credentials in the registered nodes. Another attribute is registering the possible frequencies that can be provisioned for use (e.g., Low, Mid, High frequency ranges). Another attribute is the verifying and guaranteeing the geographical reach of the spectrum.

The final part of the set-up phase is to normalize the spectrum for use by first defining standard spectrum and data models, format and attributes for all spectrum. Incoming spectrum is syntactically verified, and an inventory of spectrum is to be continuously managed. After the set-up phase is complete, the provisioning phase occurs where frequencies and radio channels are provisioned and attributes for virtual radio networks and potential neutral EPC provider are assigned. A spectrum aggregator collects spectrum and organizes the frequencies into logical bundles. This spectrum aggregator defines spectrum derivatives and defines jurisdiction and region of the spectrum. A quality assurer verifies the usability of the spectrum and carries out consistency and quality checks. The quality assurer identifies invalid spectrum and jurisdictional problems and rejects this unusable spectrum. The quality assurer is a profit center even if unlicensed spectrum is being qualified because the cost of high-quality spectrum that has been analyzed for correctness and quality has value in the marketplace.

In these examples, the radio virtualization manager (RVM) runs in the cloud, such as in a public cloud provided as a service or in a self-hosted private cloud. The RVM handles the centralized control of resources in the nodes and the cloud that are needed for the network, e.g., 5GRAN & 5GC. In general, the major components include: a resource database that contain information on all nodes; a service request handler; monitoring and logging; and support for node registration. In general, the spectrum resource allocation database as depicted in FIG. 22 contains an entry for each FZnode in the system. In this example, the resource database includes at least: a name of node; list of capabilities, e.g., can run CU, DU, etc.; an interconnect list that shows how the node is connected to other nodes; radio Infrastructure Slice list, a list of slices that use the node; and security keys

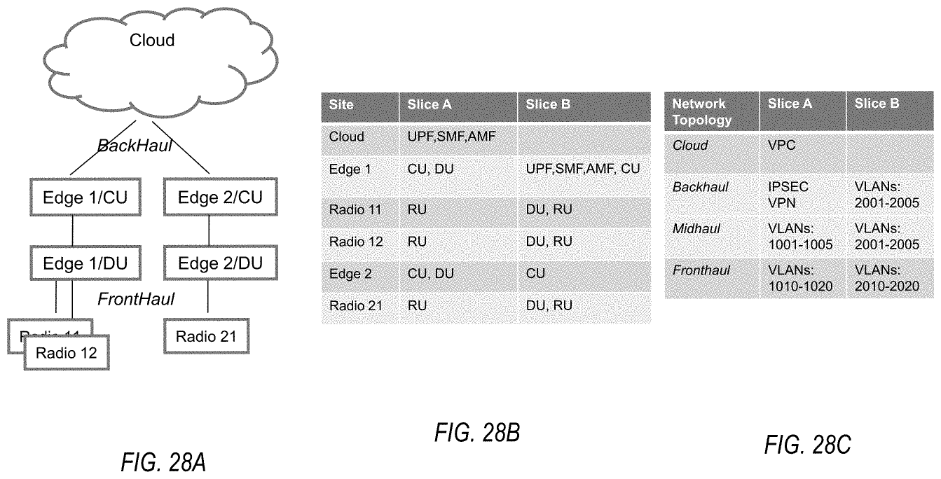

FIG. 28A is a system block diagram of a sliced infrastructure node and network example in accordance with the present disclosure. The figure shows a cloud where managers are located (such as VSM). In this example the packet core VNF components (UPF, SMF, AMF) are also placed in the cloud for slice A. The cloud is connected via a backhaul network to a set of edge sites. In the example there are two edge sites, Edge 1 and Edge 2. The edge sites connect the Radios 11, 12, and 21 via a fronthaul network. The edge sites host different applications in the different sites, for example, Edge site 1 hosts a CU and a DU in slice A, but a UPF, SMF, AMF, CU in slice B.

FIG. 28B is a table of a sliced infrastructure node and network example in accordance with the present disclosure. The table shows flexible VNF allocation and which VNF components are placed in which site. Two slices are shown, A and B and the table shows how different applications are located in the two slices. In slice A, the UPF, SMF, and AMF are placed in the cloud, whereas in slice B they are located in Edge 2. Likewise, CU and DU placement are different in slices A and B.

FIG. 28C is shows a table with sliced network infrastructure resources in accordance with the present disclosure. The figure shows how the secure networking in slice A is implemented by a Virtual Private Network (VPC) as provided by a public cloud service, how an IPSEC tunneled Virtual Private Network (VPN) is used to provide connectivity, and security over a backhaul, and how a multitude of VLANs are used between edge sites and radios to provide connectivity and isolation between slices between sites and over the fronthaul.

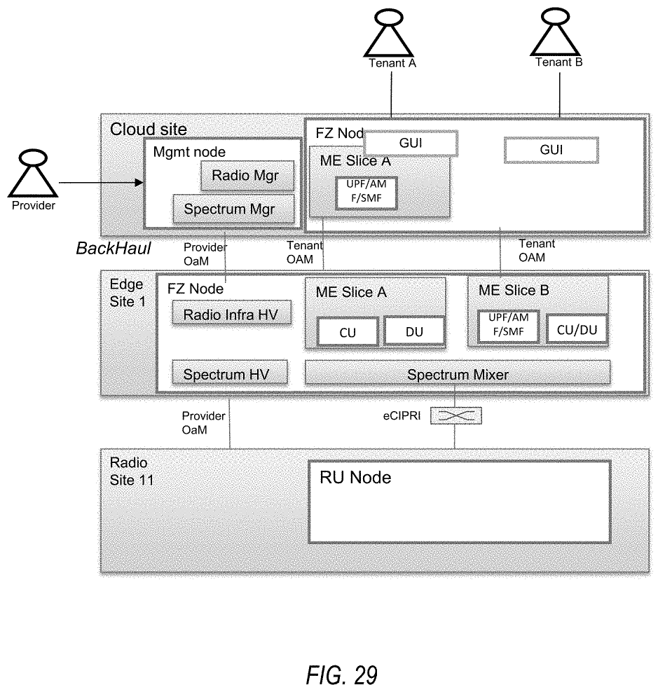

FIG. 29 is a block diagram of an edge plus cloud site in accordance with the present disclosure. In this example, the system is shown communicating with two tenants (tenant A and B) and a provider. The system includes a cloud site and backhaul that includes edge site 1 and radio site 11. The Cloud site includes a management node and a FZ node. The FZ node include a first GUI corresponding to tenant A, a second GUI corresponding to tenant B, and a ME slice A having an UPF/AMF/SMF, which are packet-core VNFs. The management node includes a radio manager and spectrum manager.

The edge site 1 includes a FZ Node having a radio infrastructure HV, spectrum HV, ME slice A, ME slice B, and spectrum mixer. The ME slice A includes a CU and DU and the ME slice B includes a UPF/AM and F/SMF and a CU/DU. The radio site 11 includes a RU Node. The provider OAM ensures connectivity and management for the provider actor to all system components in the system, including connectivity over the backhaul in the upper part of the pfigure as well as over the fronthaul in the lower part of the figure. Data transfer over the fronthaul, such as between the spectrum mixer and the radio nodes can run over a standard packet switched network using some standardized framing, such as “eCPRI.”

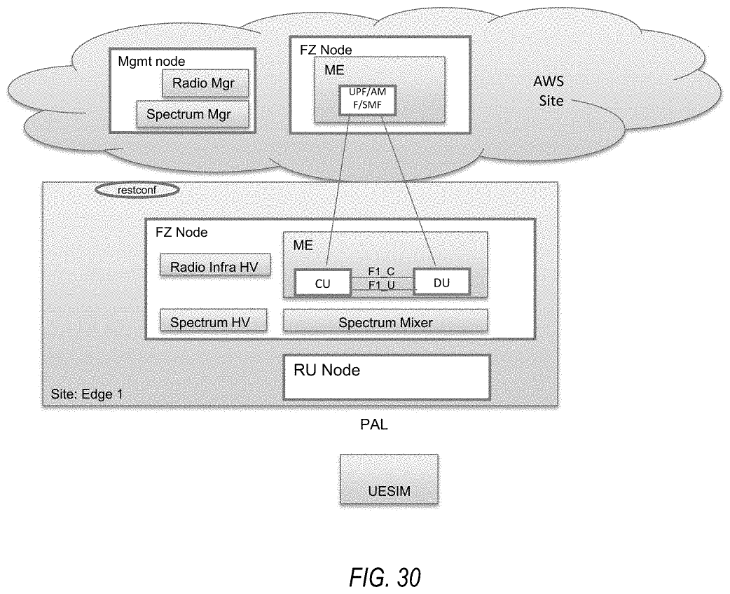

FIG. 30 is a system block diagram of an example of an implementation of an infrastructure slice, spectrum mixer, and radio hypervisor at a centralized unit and distributed unit at an edge site in accordance with the present disclosure.

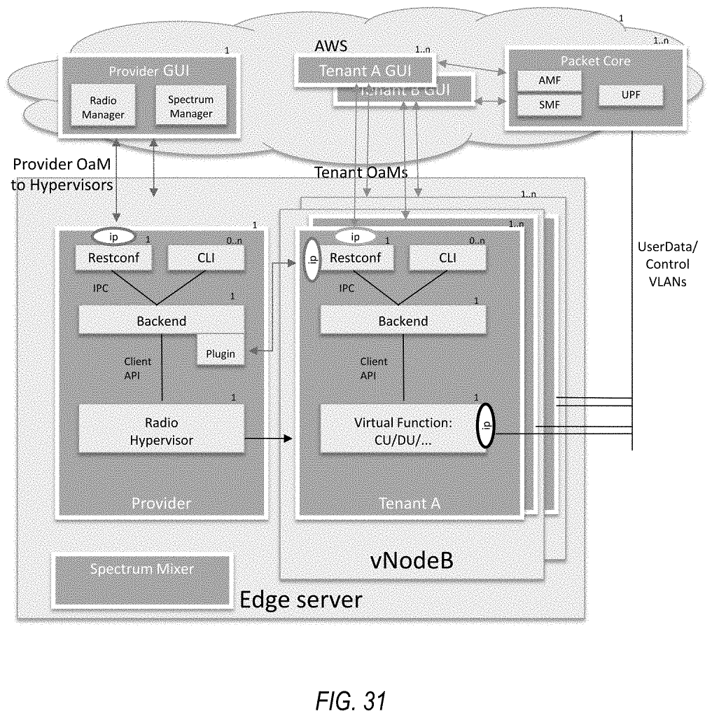

FIG. 31 is a system block diagram of an example of an implementation of the MMCS in accordance with the present disclosure. In this example, the MMCS is configured so that CU and DU run on an edge server such as, for example, a Dell® server 740 produced by Dell Corporation of Austin, Tex. In this example, provider graphic user interface (GUI), tenant GUI, and packet core are shown as residing on a remote network such, as for example, at one or more services located a remote locations and communicating over a network such as, for example, the Internet (herein generally referred to as “the Cloud”). In this example, the provider GUI includes a radio manager and spectrum manager, the AWS may include a plurality of tenant GUIs such as tenant A GUI and tenant B GUI. The packet core may include an AMF, UPF, and SMF.

The edge servicer includes a provider, a vNode B, and a spectrum mixer. The vNode B may include multiple tenants including tenant A. Tenant A may include a restconf, CLI, backend, and virtual functions such CU, DU, etc. The Provider includes a radio hypervior, backend, restconf, CLI, and plugin.

In this example, the provider is an entity that maintains the entire infrastructure such as, for example, a cellular or radio tower operator. The tenant is a user of a slice such as, for example, a business that utilizes the provider's infrastructure resources to manage the tenant's private network. In this example, radio manager in the provider GUI is configured to allocate resources to provide all resources needed at each edge server to run CU and DU instances. The MMCS is configured to utilize the radio manager of the provider GUI. The spectral manager is a virtual spectrum manage that spectrum curates where the spectral manager is configured to allocate the spectrum needed to by each slice and/or tenant. In general, the spectrum is disturbed to all the tenant virtual network functions (VNFs) or managed function (MF in 3GPP) in the network utilizing the providers hypervisor OaM. In this example, restcof, CLI, and backend OaM user Clixon.

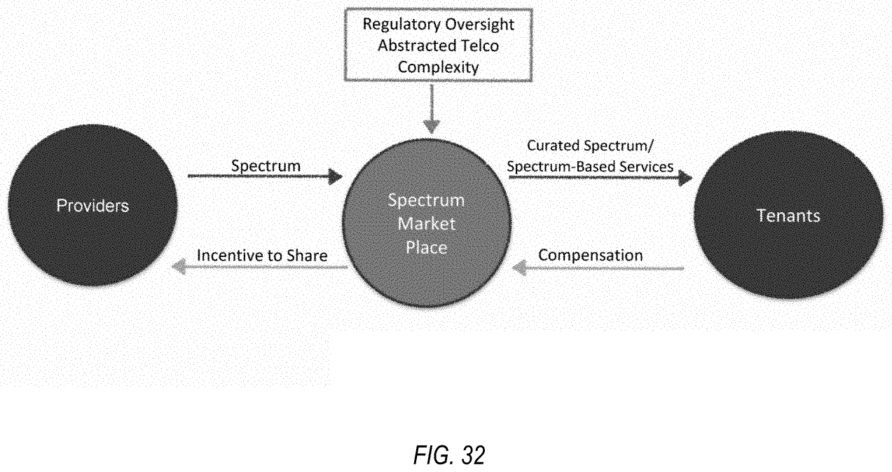

FIG. 32 provides a functional diagram overview showing how the present invention creates a new dynamic marketplace where users and sellers trade spectrum usage. A regulatory oversight entity is charged with managing the spectrum marketplace and acts as the final arbiter of any conflicts in spectrum allocation. Spectrum providers have the spectrum assets that are provided to the spectrum marketplace. Tenants are the users of the spectrum resources who provide consideration for their use of the spectrum to the spectrum providers. The spectrum marketplace provides curated spectrum and provides spectrum-based services to tenants. In addition, the spectrum marketplace provides incentives for providers to share spectrum.

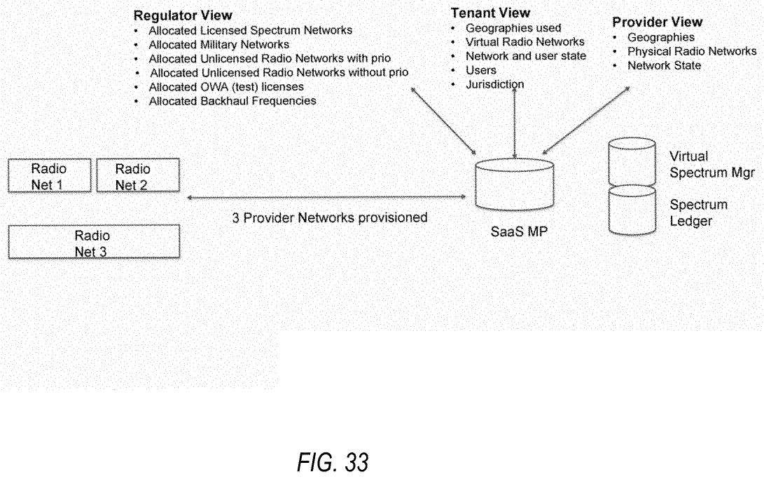

FIG. 33 provides an exemplary functional diagram overview showing the one typical provider and tenant private network provisioning system represented by hardware blocks. The provider plays a physical role and contributes the physical infrastructure for the wireless communication system. The tenant embodies a virtual role where private network provisioning is based on use of the physical infrastructure from the provider.

The regulator has rights and privileges to allow for the allocation of licensed spectrum networks, military networks, unlicensed radio networks with priority, unlicensed radio networks without priority, OWA (test) licenses and backhaul frequencies. Furthermore, the regulator has the role and responsibility, or delegates said role and responsibility to an agency or private entity, for arbitrating the conflict for the use of any of these spectrum frequencies.

The provider allocates to individual tenants the geographies of operation, physical radio networks and network states.

The tenant has the designated ability to allocate to its users the sub-geographies of network use within its geographical area, virtual radio networks, network and user states, user privileges and jurisdictions.

The spectrum ledger cryptographically validates spectrum transactions for the buying and selling of new mobile networks and/or virtual private networks. It also performs the function of logging billing operations using parameters of time and data, among other variables. The spectrum ledger works in conjunction with the spectrum manager to verify usage of spectrum assets supplied by the providers of immutable mobile infrastructure.

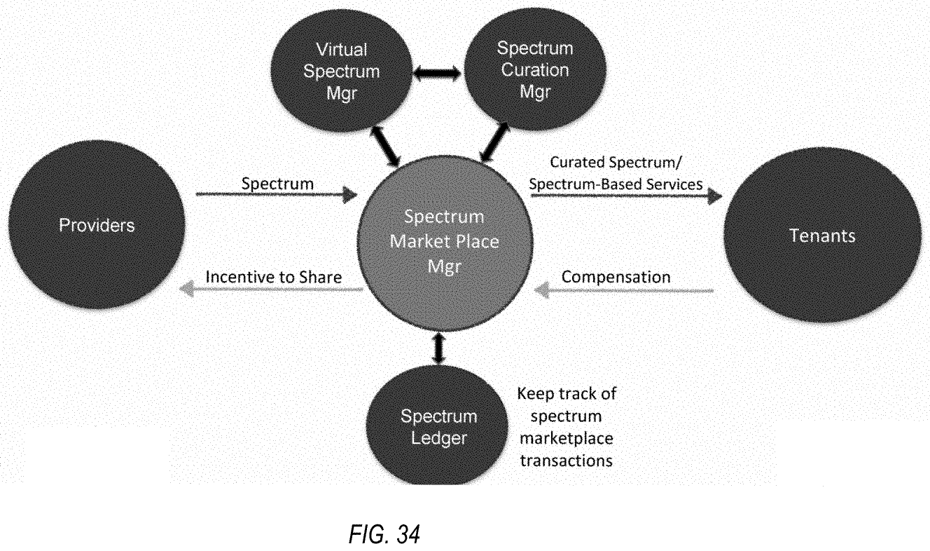

FIG. 34 provides another more detailed functional diagram further describing how the spectrum marketplace is implemented allocated spectrum. The virtual spectrum manager has been disclosed and described in detail in the previous sections of this disclosure. The spectrum curation manager has the role of providing the channels available for use by the tenants. Spectrum curation is the process of emulating a low-noise, highly available communication channel using a collection of communication channels which have time-varying and spatially varying levels of noise and availability. This has the effect of foundationally enhancing the value of raw unlicensed spectrum by improving its quality for the tenant. There are many potential mechanisms and steps to create this high quality of communication from the available various spectra, including steps related to analysis, modeling, provisioning, message division/multiplexing, transmission, message reconstruction, monitoring, correction/recovery, and adaptation.

Spectrum curation by the spectrum manager comprises the following method steps in conjunction with the enumerated physical assets:

The first step is to provide raw spectrum Inventory for asset management comprising the following sub-steps:

(1) collects and lists available spectrum assets available to a node or node set;

(2) collects and lists metadata about spectrum assets including time-varying data related to measurement of noise and/or interference;

(3) conducts inventory registry of spectra including the usage status of each channel on a fine-grained time scale, enabling multiple networks/tenants etc. to intelligently and efficiently share spectrum; and

(4) models the spectrum using a Spectrum Modeler to include geospatial attributes and interference attributes, among other parameters.

The spectrum modeler models the performance and reliability of synthesized radio channels based on data from Spectrum Monitor and Channel Monitor. The spectrum modeler inputs data from Spectrum Monitor and recommends the composition of a synthetic radio channel based on available assets. The spectrum monitor performs the function of collecting the usage and noise/interference data from all physical radio channels/spectra at the node and then synthesizes a time and spatial noise model from point-observations. The channel monitor monitors the utilization of synthetic channels and provides data on throughput and headroom available for additional usage.

The second step is to provide spectrum aggregation comprising the following sub-steps:

(1) manages and allocates spectrum inventory assets and produces a synthesized radio channel;

(2) uses the channel monitor to support decision on new synthetic radio channel allocation; provides for the creation of synthesized radio channels for multiple tenants where each tenant has a secure and exclusive momentary use of a synthetic channel based on predetermined security needs;

(3) distributes to tenants needed assets and resources with time-based multiplexing or other means to optimally share assets;

(4) outputs metadata on utilization of synthesized channel as well as utilization of underlying assets; and

(5) releases spectrum assets back to inventory when no longer needed by tenants.

In this example, the spectrum curation process is used to turn raw unlicensed spectrum into high quality spectrum to use or share. Spectrum management is bifurcated into (1) a set-up phase and (2) a provisioning phase as shown. The set-up phase comprises the trading of raw spectrum and the normalization of spectrum.

The trading of raw spectrum is conducted by a spectrum trading auction algorithm. Anything deemed of value can be used in the trading of spectrum, including, for example, the following: exchanging government currencies for spectrum; exchanging one part of the spectrum for another, more desirable, slice of spectrum; exchanging decentralized digital currencies for spectrum, such as, for example, with Bitcoin; and registering tenants and providers in a privately managed spectrum exchange operator, similar to trading on a stock exchange. The trading of spectrum is conducted using auction algorithms that are well known to those of ordinary skill in the art. For example, auction algorithms are discussed in detail by Dimitri P. Bertsekas in Auction Algorithms for Network Flow Problems: A Tutorial Introduction, Computational Optimization and Applications, 1, (1992), 7-66, Kluwer Academic Publishers. In one embodiment, the regulator has the role and responsibility for spectrum trading. This regulator can be a government agency or a private entity contracted by the government. In another embodiment, a private entity operating a network can fill this role. Regardless of the nature of the entity, the role of the regulator is to arbitrate conflicts for the use of any of these spectrum frequencies and for using the market to allocate spectrum.

Another attribute of the set-up phase is the registration of radio networks using secure means, such as, for example, AIR, vBTS and vEPC. Another attribute is storing security credentials in the registered nodes. Another attribute is registering the possible frequencies that can be provisioned for use (e.g., Low, Mid, High frequency ranges). Another attribute is the verifying and guaranteeing the geographical reach of the spectrum.

The final part of the set-up phase is to normalize the spectrum for use by first defining standard spectrum and data models, format and attributes for all spectrum. Incoming spectrum is syntactically verified, and an inventory of spectrum is to be continuously managed.

After the set-up phase is complete, the provisioning phase occurs where frequencies and radio channels are provisioned and attributes for virtual radio networks and potential neutral EPC provider are assigned. A spectrum aggregator collects spectrum and organizes the frequencies into logical bundles. This spectrum aggregator defines spectrum derivatives and defines jurisdiction and region of the spectrum.

A quality assurer verifies the usability of the spectrum and carries out consistency and quality checks. The quality assurer identifies invalid spectrum and jurisdictional problems and rejects this unusable spectrum. The quality assurer is a profit center even if unlicensed spectrum is being qualified because the cost of high-quality spectrum that has been analyzed for correctness and quality has value in the marketplace.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

The description of the different examples of implementations has been presented for purposes of illustration and description and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

What is claimed is:

1. A Multi-Spectrum and Multi-Network Communication (MSMNC) system for communicating with at least one user equipment (UE) over at least one unlicensed communication core networks and at least one licensed spectrum communication core network, where each unlicensed communication core network operates over a first band of unlicensed wireless frequencies and each licensed communication core network operates over a second band of licensed wireless frequencies, the MSMNC system comprising:
a virtual radio access network (vRAN) configured to provide a first communications link with the at least one UE, the vRAN including a plurality of control layers;
an unlicensed interference management (UIM) system configured to manage a frequency of operation of the vRAN within the first band of unlicensed wireless frequencies; and
a spectrum management system configured to provide spectrum slicing of the first band of unlicensed RF frequencies.

2. The MSMNC system of claim 1, wherein the spectrum management system is also configured to provide spectrum slicing of the second band of licensed wireless frequencies.

3. The MSMNC system of claim 2, wherein the spectrum management system includes a spectrum curation (SC) system configured to select, organize, and monitor spectrum slices of the first band of unlicensed wireless frequencies corresponding to the unlicensed core networks.

4. The MSMNC system of claim 2, wherein the SC system is also configured to select, organize, and monitor spectrum slices of the second band of licensed wireless frequencies.

5. The MSMNC system of claim 1, wherein the UIM system is also configured to manage another frequency of operation of the vRAN within the second band of unlicensed wireless frequencies.

6. The MSMNC system of claim 1, wherein the vRAN includes
at least one virtual antenna,
at least one virtual radio unit,
at least one virtual front haul network, and
at least one virtual baseband unit.

7. The MSMNC system of claim 6, further including a corresponding physical infrastructure that is utilized by the vRAN that includes
at least one antenna,
at least one radio unit,
at least one front haul network, and
at least one baseband unit.

8. The MSMNC system of claim 7, wherein the physical infrastructure includes
a memory,
an access and core networks,
a transport networks, and
a network infrastructure.

9. The MSMNC system of claim 8, wherein the access and core networks include at least one base station configured to communicate to the at least one UE.

10. The MSMNC system of claim 9, wherein the network infrastructure is a cloud infrastructure that is configured utilizing the Internet.

11. The MSMNC system of claim 8, further including one or more processors.

12. The MSMNC system of claim 5, wherein the unlicensed core communication network comprises Wi-Fi, IoT, CBRS, LTE and DAS.

13. The MSMNC system of claim 5, wherein the licensed spectrum communication core network comprises 2G, 3G, 4G and 5G.

14. A method for configuring a radio operating system (RadioOS) that communicates with at least one user equipment (UE) over at least one unlicensed communication core network and at least one licensed spectrum communication core network utilizing a Multi-Spectrum and Multi-Network Communication (MSMNC) system, where each unlicensed communication core network operates over a first band of unlicensed wireless frequencies and each licensed communication core network operates over a second band of licensed wireless frequencies, the method comprising:
providing a first communications link with the at least one user equipment (UE) utilizing a virtual radio access network (vRAN);
managing a frequency of operation of the vRAN within the first band of unlicensed wireless frequencies utilizing an unlicensed interference management (UIM) system; and
providing spectrum slicing of the first band of unlicensed RF frequencies with a spectrum management system.

15. The method of claim 14, further providing spectrum slicing of the second band of licensed wireless frequencies.

16. The method of claim 15, further selecting, organizing, and monitoring spectrum slices of the first band of unlicensed wireless frequencies corresponding to the unlicensed core networks.

17. The method of claim 16, further selecting, organizing, and monitoring spectrum slices of the second band of licensed wireless frequencies.

18. The method of claim 14, further managing another frequency of operation of the vRAN within the second band of unlicensed wireless frequencies.

19. A Multi-Spectrum and Multi-Network Communication (MSMNC) system for dynamically communicating over both licensed and unlicensed bands of a radio spectrum, the MSMNC comprising:
a physical infrastructure including a pool of resources, wherein the pool of resources includes
a memory,
at least one processor,
a network infrastructure,
a plurality of transport networks, and
access and core networks
wherein the plurality of transport networks includes a first transport network configured for operation on a first unlicensed portion of the radio spectrum and a second transport network configured for operation on a second unlicensed portion of the radio spectrum;
an unlicensed interference management (UIM) system;
a spectrum management system; and
a computer readable medium on the memory configured to store machine instructions than when executed by the at least one processor causes the MSMNC system to create a plurality of slices of a virtual radio access network (vRAN),
wherein each vRAN slice of the plurality of RAN slices are dynamically isolated from the pool of network resources.

20. A method for trading spectrum usage in a Multi-Spectrum and Multi-Network Communication (MSMNC) system between spectrum providers and tenants,
wherein said spectrum is allocated by a regulator that arbitrates any conflict of unlicensed radio frequencies and
wherein a spectrum ledger validates the buying and selling of new mobile networks and virtual private networks and
wherein a spectrum manager verifies the availability and usage of spectrum assets in the following steps:
(1) provisioning raw spectrum inventory and
(2) aggregating spectrum to tenants.

21. The method of claim 20, where provisioning raw spectrum inventory comprises the following steps:
(a) collecting and listing available spectrum assets available to a node or node set;
(b) collecting and listing metadata about spectrum assets including time-varying data related to measurement of noise and/or interference;
(c) conducting inventory registry of spectra including the usage status of each channel on a fine-grained time scale, enabling multiple networks/tenants etc. to intelligently and efficiently share spectrum; and
(d) modeling the spectrum to include geospatial attributes and interference attributes, among other parameters.

22. The method of claim 20, where aggregating spectrum to tenants comprises the following steps:
(a) managing and allocating spectrum inventory assets to tenants using an auction algorithm;
(b) producing and synthesizing auctioned radio channels;
(c) monitoring the usage of each synthesized radio channloe to support decision on new synthetic radio channel allocation;
(d) providing for the creation of synthesized radio channels for multiple tenants where each tenant has a secure and exclusive momentary use of a synthetic channel based on predetermined security needs;
(e) distributing to tenants needed assets and resources with time-based multiplexing or other pre-determined means to optimally share assets;
(f) outputing metadata on utilization of synthesized channel as well as utilization of underlying assets; and
(g) releasing spectrum assets back to inventory when no longer needed by tenants.

23. A spectrum auction system for trading spectrum usage in a Multi-Spectrum and Multi-Network Communication (MSMNC) system between spectrum providers and tenants, the spectrum auction system comprising:
a memory;
at least one processor;
a network infrastructure;
a plurality of transport networks;
access and core networks, and
wherein the plurality of transport networks includes a first transport network configured for operation on a first unlicensed portion of the radio spectrum and a second transport network configured for operation on a second unlicensed portion of the radio spectrum,
wherein the memory includes a computer readable medium configured to store machine instructions than when executed by the at least one processor causes the spectrum auction system to
allocate a spectrum from a spectrum provider to a tenant,
wherein said spectrum is allocated by a regulator that arbitrates any conflict of unlicensed radio frequencies,
wherein a spectrum ledger validates the buying and selling of new mobile networks and virtual private networks, and
wherein a spectrum manager verifies the availability and usage of spectrum assets in the following steps:
provisioning raw spectrum inventory and
aggregating spectrum to tenants.

24. A radio infrastructure virtualization system of a Multi-Spectrum and Multi-Network Communication (MSMNC) system for communicating with at least one user equipment (UE) over at least one unlicensed communication core networks and at least one licensed spectrum communication core network, where each unlicensed communication core network operates over a first band of unlicensed wireless frequencies and each licensed communication core network operates over a second band of licensed wireless frequencies, where the MSMNC includes a radio access network (RAN) configured to provide a first communications link with the at least one UE and the RAN includes a plurality of control layers, the radio infrastructure virtualization system comprising:
means for sharing physical resources on a RU, front haul and associated DU, CU, or antenna that act as a base station to create a virtual radio infrastructure slice; and
means for dividing and grouping radio frequency bands into fully isolated spectrum slices of the frequencies where the spectrum slices can be divided into frequencies and time shared.

25. The radio infrastructure virtualization system of claim 24, further comprising a radio hypervisor for managing radio slices of the MSMNC system for communicating with at least one UE over at least one unlicensed communication core networks and at least one licensed spectrum communication core network, where each unlicensed communication core network operates over a first band of unlicensed wireless frequencies and each licensed communication core network operates over a second band of licensed wireless frequencies, where the MSMNC includes the RAN configured to provide a first communications link with the at least one UE and the RAN includes a plurality of control layers, the radio hypervisor comprising:
means for managing the radio slicing and schedules over of wireless resources in the RAN,
means for performing the following steps
keep record of all allocated and non-allocated resources in the DU,
allocate resources for a radio slice,
deallocate resources from a radio slice,
get and execute commands from the virtualization manager,
allocate a new radio slice with specific resources; allocate the radio slice,
change radio slice resources,
manage status requests, and
inform a virtualization manager of the status of changes.
wherein the radio hypervisor is integrated into units of the RAN that include a radio antenna, RU, distributed unit (DU), CU and fronthaul network,
wherein the radio hypervisor is configured to share the radio infrastructure using a radio slice virtualization.

26. The radio infrastructure virtualization system of claim 25, further comprising the radio virtualization manager in signal communication with the radio hypervisor, the radio virtualization manager is configured to
keep a record of all the units (RUs, DU, CUs) controlled by the virtualization manager and is part of/or connected to an Operations and Management (OaM) system for the provider of the radio infrastructure slices, and
optimize the over the air radio resources of the DU 1000 and schedules the air radio resources as needed.

27. The radio infrastructure virtualization system of claim 26, wherein the OaM is a system that controls, monitors, collect logs and provide the user the ability to affect the system in a way that includes bring up, shutdown, and resource planning the system.

28. A Multi-Spectrum and Multi-Network Communication (MSMNC) system for communicating with at least one user equipment (UE) over at least one unlicensed communication core networks and at least one licensed spectrum communication core network, where each unlicensed communication core network operates over a first band of unlicensed wireless frequencies and each licensed communication core network operates over a second band of licensed wireless frequencies, the MSMNC system comprising:
a virtual radio access network (vRAN);
an unlicensed interference management (UIM) system;
means for providing spectrum slicing of the first band of unlicensed RF frequencies,
wherein the vRAN provides a first communications link with the at least one UE, the vRAN including a plurality of control layers and the UIM system manages a frequency of operation of the vRAN within the first band of unlicensed wireless frequencies, and
wherein the means for providing spectrum slicing includes a spectrum management system.

29. The MSMNC system of claim 28, wherein the means for providing spectrum slicing also provides spectrum slicing of the second band of licensed wireless frequencies.

30. The MSMNC system of claim 29, wherein the means for providing spectrum slicing includes a spectrum curation (SC) system configured to select, organize, and monitor spectrum slices of the first band of unlicensed wireless frequencies corresponding to the unlicensed core networks.

31. The MSMNC system of claim 30, wherein the SC system is also configured to select, organize, and monitor spectrum slices of the second band of licensed wireless frequencies.

32. The MSMNC system of claim 28, wherein the UIM system is also configured to manage another frequency of operation of the vRAN within the second band of unlicensed wireless frequencies.

33. A Multi-Spectrum and Multi-Network Communication (MSMNC) system for communicating with at least one user equipment (UE) over at least one unlicensed communication core networks and at least one licensed spectrum communication core network, where each unlicensed communication core network operates over a first band of unlicensed wireless frequencies and each licensed communication core network operates over a second band of licensed wireless frequencies, the MSMNC system comprising:
a memory;
at least one processor;
a network infrastructure;
a plurality of transport networks;
access and core networks, and
wherein the plurality of transport networks includes a first transport network configured for operation on a first unlicensed portion of the radio spectrum and a second transport network configured for operation on a second unlicensed portion of the radio spectrum,
wherein the memory includes a computer readable medium configured to store machine instructions than when executed by the at least one processor causes the MSMNC system to
provide a first communications link with the at least one user equipment (UE) utilizing a virtual radio access network (vRAN);
manage a frequency of operation of the vRAN within the first band of unlicensed wireless frequencies utilizing an unlicensed interference management (UIM) system; and
provide spectrum slicing of the first band of unlicensed RF frequencies with a spectrum management system.

34. The MSMNC system of claim 33, wherein the at least one processor further causes the MSMNC system to provide spectrum slicing of the second band of licensed wireless frequencies.

35. The MSMNC system of claim 34, wherein the at least one processor further causes the MSMNC system to select, organize, and monitor spectrum slices of the first band of unlicensed wireless frequencies corresponding to the unlicensed core networks.

36. The MSMNC system of claim 35, wherein the at least one processor further causes the MSMNC system to select, organize, and monitor spectrum slices of the second band of licensed wireless frequencies.

37. The MSMNC system of claim 33, wherein the at least one processor further causes the MSMNC system to manage another frequency of operation of the vRAN within the second band of unlicensed wireless frequencies.

38. The MSMNC system of claim 33, wherein the vRAN includes
at least one virtual antenna,
at least one virtual radio unit,
at least one virtual front haul network, and
at least one virtual baseband unit.

39. The MSMNC system of claim 38, wherein the access and core networks include at least one base station configured to communicate to the at least one UE.

40. The MSMNC system of claim 39, wherein the network infrastructure is a cloud infrastructure that is configured utilizing the Internet.

41. The MSMNC system of claim 39, wherein the unlicensed core communication network comprises Wi-Fi, IoT, CBRS, LTE and DAS.

42. A spectrum virtualization manager for keeping track of all available spectrum resources and enabling automatic run-time configuration, the spectrum virtualization manager comprising:
a memory;
at least one processor;
wherein the memory includes a computer readable medium configured to store machine instructions than when executed by the at least one processor causes the spectrum virtualization manager to
allow multiple tenants to share radio signaling resources by virtualization of the spectrum slices,
wherein the spectrum slices are allocated at run-time with limited interference with the radio access networks (RANs) that already use other parts of the spectrum,
whereby a user may provision and bring up a new RAN in parallel to the already running RANs with minimal interreferences.

43. The spectrum virtualization manager of claim 42, wherein spectrum virtualization manager is configured to allow the multiple tenants/RANs to share frequency band resources fine-grained and dynamically and the flexible allocation of spectrum resources to and from the RAN depending on predefined requirements.

44. The spectrum virtualization manager of claim 43, wherein the processor further causes the spectrum virtualization manager to:
allocate spectrum resources to a first tenant, wherein the resources include
the antennas and corresponding radio sectors to use,
what frequencies are allocated to the tenant,
time sharing properties allocated to the tenant,
MIMO/Beamforming parameters allocated to the tenant, and
transmission power allocated to the tenant;
allocate resource that are provisioned by a radio operating system (RadiOS), wherein the RadiOS will configure the equipment in order to run an isolated RAN with the allocated spectrum resources, wherein the RAN can later operate in isolation from other RANs utilizing parts of the same physical equipment;
activate and maintain the RAN according to 3gpp and/or other applicable OAM systems;
keeping the allocated spectrum resources isolated;
modifying the spectrum virtualization parameters according to changed requirements and/or resource availability during the lifetime of the spectrum slice;
inactivating the spectrum virtual slice for a period of time, wherein the period of time is for maintenance, temporary disturbances, or other high priority spectrum activity; and
releasing spectrum resource making resources available to other spectrum slices.

45. The spectrum virtualization manager of claim 42, wherein the spectrum virtualization manager is a spectrum virtualization cloud manager wherein the spectrum virtualization cloud manager includes
a frequency (FZ) node, wherein the FZ node includes a radio hypervisor,
a radio manager and
a spectrum manager.
